(19) United States
(12) Patent Application Publication
(10) Pub. No.: US 2023/0413356 A1
(43) Pub. Date: Dec. 21, 2023

(54) Managing Secondary Cell Group Deactivation and Activation

(71) Applicant: GOOGLE LLC, Mountain View, CA (US)

(72) Inventor: Chih-Hsiang Wu, Taoyuan City (TW)

(21) Appl. No.: 18/250,357

(22) PCT Filed: Oct. 20, 2021
(86) PCT No.: PCT/US21/55764

§ 371 Date: Apr. 25, 2023

Related U.S. Application Data
(60) Provisional application No. 63/106,173, filed on Oct. 27, 2020.
(60) Provisional application No. 63/104,164, filed on Oct. 22, 2020.

(51) Int. Cl. H04W 76/15; H04W 76/27

(52) U.S. Cl. CPC H04W 76/15; H04W 76/27; H04W 88/06

(57) ABSTRACT

A network node, operating as a secondary node (SN) for a user equipment (UE) communicating in dual connectivity (DC) with a master node (MN) and the SN, can implement a method for managing deactivation and activation of a secondary cell group (SCG). The method includes detecting (2302) a first indication that an activation status of the SCG is to change, and changing (2304) the activation status at the SN in response to the detecting. Further, the method includes reactivating or releasing (2306) the SCG in response to detecting a second indication related to the SCG.

### TECHNICAL FIELD

This disclosure relates generally to wireless communications and, more particularly, to deactivating and activating a secondary cell group (SCG).

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A user device (or user equipment, commonly denoted by the acronym “UE”) in some cases can concurrently utilize resources of multiple network nodes, e.g., base stations, interconnected by a backhaul. When these network nodes support the same radio access technology (RAT) or different RATs, this type of connectivity is referred to as Dual Connectivity (DC) or Multi-Radio DC (MR-DC), respectively. Typically, when a UE operates in DC or MR-DC, one base station operates as a master node (MN), and the other base station operates as a secondary node (SN). The backhaul can support an X2 or Xn interface, for example.

The MN can provide a control-plane connection and a user-plane connection to a core network (CN), whereas the SN generally provides only a user-plane connection. The cells associated with the MN define a master cell group (MCG), and the cells associated with the SN define a secondary cell group (SCG). The UE and the base stations MN and SN can use signaling radio bearers (SRBs) to exchange radio resource control (RRC) messages, as well as non-access stratum (NAS) messages.

There are several types of SRBs that a UE can use when operating in DC. SRB1 and SRB2 resources allow the UE and the MN to exchange RRC messages related to the MN and to embed RRC messages related to the SN, and can be referred to as MCG SRBs. SRB3 resources allow the UE and the SN to exchange RRC messages related to the SN, and can be referred to as an SCG SRB. Split SRBs allow the UE to exchange RRC messages directly with the MN using radio resources of the MN, the SN, or both the MN and SN. Further, the UE and the base stations (e.g., MN and SN) use data radio bearers (DRBs) to transport data on a user plane. DRBs terminated at the MN and using the lower-layer resources of only the MN can be referred to as MCG DRBs, DRBs terminated at the SN and using the lower-layer resources of only the SN can be referred to as SCG DRBs, and DRBs terminated at the MN or SN but using the lower-layer resources of both the MN and the SN can be referred to as split DRBs. DRBs terminated at the MN but using the lower-layer resources of only the SN can be referred to as MN-terminated SCG DRBs. DRBs terminated at the SN but using the lower-layer resources of only the MN can be referred to as SN-terminated MCG DRBs.

However, operating in DC with the MN and the SN places high power demands on the UE. Further, the amount of data that the UE has to exchange with the SN varies with time. For example, at a first time, the UE may not have data to exchange with the SN. As a result, the UE may be consuming large amounts of power to support a link with the SN that the UE is not actively using. However, a short time later, the UE may have data to exchange with the SN. Thus, it may be inefficient for the RAN to release the SN while there is low data activity for the UE, even in scenarios where the UE would benefit from the power savings.

### SUMMARY

Accordingly, a network node and/or a UE implement the techniques of this disclosure to manage deactivation and activation of an SCG. When the SCG is deactivated, the SN and the UE suspend communications over the SCG. However, the SN and the UE may each retain configurations for the SCG, so that the SN and the UE can resume communicating over the SCG if the SCG is reactivated. Depending on the implementation, the UE, the MN, or the SN may determine to deactivate or reactivate the SCG.

For example, a network node operating as the SN can detect that an activation status of the SCG is to change. For example, the SN may detect data inactivity for the UE on the SCG or may receive an indication that the UE would prefer to operate in single connectivity (e.g., because of a battery level of the UE). Alternatively, the SN may receive an indication from the MN or the UE instructing the SN to deactivate the SCG. In response, the SN can change, at the SN, the activation status of the SCG (i.e., the SN can deactivate the SCG).

At a later time, if the SN detects data activity for the UE, receives an updated UE preference, or receives an instruction from the UE or the MN, the SN can reactivate the SCG. Alternatively, while the SCG is deactivated, the MN may notify the SN that the UE is to perform a handover to a different SN. The SN can then release the deactivated SCG.

The UE can implement similar techniques for managing deactivation and activation of the SCG at the UE.

One example embodiment of these techniques is a method implemented in a network node, operating as a secondary node (SN) for a user equipment (UE) communicating in dual connectivity (DC) with a master node (MN) and the SN, for managing deactivation and activation of a secondary cell group (SCG). The method includes detecting a first indication that an activation status of the SCG is to change, and changing the activation status at the SN in response to the detecting. Further, the method includes reactivating or releasing the SCG in response to detecting a second indication related to the SCG.

Another example embodiment of these techniques is a network node including processing hardware and configured to implement the method above.

A further example embodiment of these techniques is a method implemented in a UE, communicating in DC with a RAN via an MN and an SN, for managing deactivation and activation of an SCG. The method includes detecting a first indication that an activation status of the SCG is to change, and changing the activation status at the UE in response to the detecting. Further, the method includes reactivating or releasing the SCG in response to detecting a second indication related to the SCG.

Yet another example embodiment of these techniques is a UE including processing hardware and configured to implement the method above.

### BRIEF DESCRIPTION OF THE DRAWINGS

FIG. 1A is a block diagram of an example system in which one or more base stations and/or a user equipment (UE) can implement the techniques of this disclosure for deactivating and activating an SCG between the UE and an SN;

FIG. 1B is another block diagram of an example system in which a radio access network (RAN) and a user device can implement the techniques of this disclosure for deactivating and activating an SCG related to an SN;

FIG. 1C is a block diagram of an example base station including a central unit (CU) and a distributed unit (DU) that can operate in the system of FIG. 1A or FIG. 1B;

FIG. 2 is a block diagram of an example protocol stack according to which the UE of FIG. 1A or FIG. 1B can communicate with base stations;

FIG. 3A is an example message sequence in which a master node (MN) causes a secondary node (SN) to deactivate an SCG for a UE and later reactivate the deactivated SCG for the UE;

FIGS. 3B-3C are example message sequences in which an SN deactivates an SCG for a UE and later reactivates the deactivated SCG for the UE;

FIG. 3D is an example message sequence in which a UE causes an SN to deactivate an SCG for the UE and later causes the SN to activate the deactivated SCG for the UE;

FIGS. 4A-4D are example message sequences similar to FIGS. 3A-3D, but where the SN includes both a central unit (CU) and a distributed unit (DU);

FIGS. 5A-5B are example message sequence similar to FIGS. 3A-3D, but where portions of a single base station serve as the MN and the SN;

FIG. 6 is an example message sequence in which a master node (MN) causes a secondary node (SN) to deactivate a SCG for a UE and later changes the SN for the UE or in which a MN adds a deactivated SCG for a UE;

FIG. 7 is an example message sequences similar to FIG. 6, but where the SN includes both a central unit (CU) and a distributed unit (DU);

FIG. 8A-B is are flow diagrams of example methods for deactivating or activating an SCG, which can be implemented by a UE of this disclosure;

FIGS. 9-11B is a flow diagram of an example method for facilitating deactivating an SCG, which may be implemented by an SN;

FIG. 12 is a flow diagram of an example method of responding to an SN Modification Request message received from an MN and including an indication to deactivate or activate an SCG for a UE, which can be implemented by an SN;

FIG. 13 is a flow diagram of an example method of responding to an SN request message received from an MN and deactivating an SCG for a UE, which can be implemented by a CU of an SN;

FIG. 14 is a flow diagram of an example method of responding to an SN request message received from an MN and activating an SCG for a UE, which can be implemented by a CU of an SN;

FIG. 15 is a flow diagram of an example method for providing a DU configuration to a CU that a UE can use to activate an SCG, which can be implemented by a DU of an SN;

FIGS. 16A-18 are flow diagrams of example methods for deactivating or activating an SCG, which can be implemented by a UE of this disclosure;

FIGS. 19-20 are flow diagrams of example methods for deactivating or activating an SCG, which can be implemented by a RAN of this disclosure;

FIGS. 21-22 are flow diagrams of example methods for deactivating or activating an SCG, which can be implemented by a UE of this disclosure;

FIG. 23 is a flow diagram of an example method for managing deactivation and activation of an SCG, which can be implemented in a network node of FIGS. 1A-1C; and

FIG. 24 is a flow diagram of an example method for managing deactivation and activation of an SCG, which can be implemented in a UE of FIG. 1A.

### DETAILED DESCRIPTION OF THE DRAWINGS

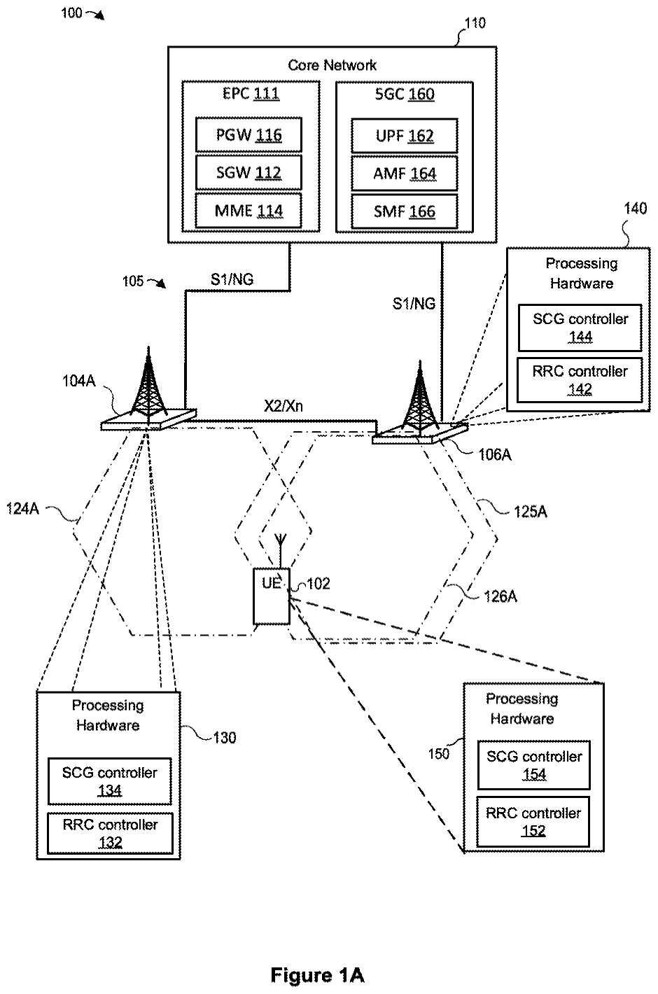

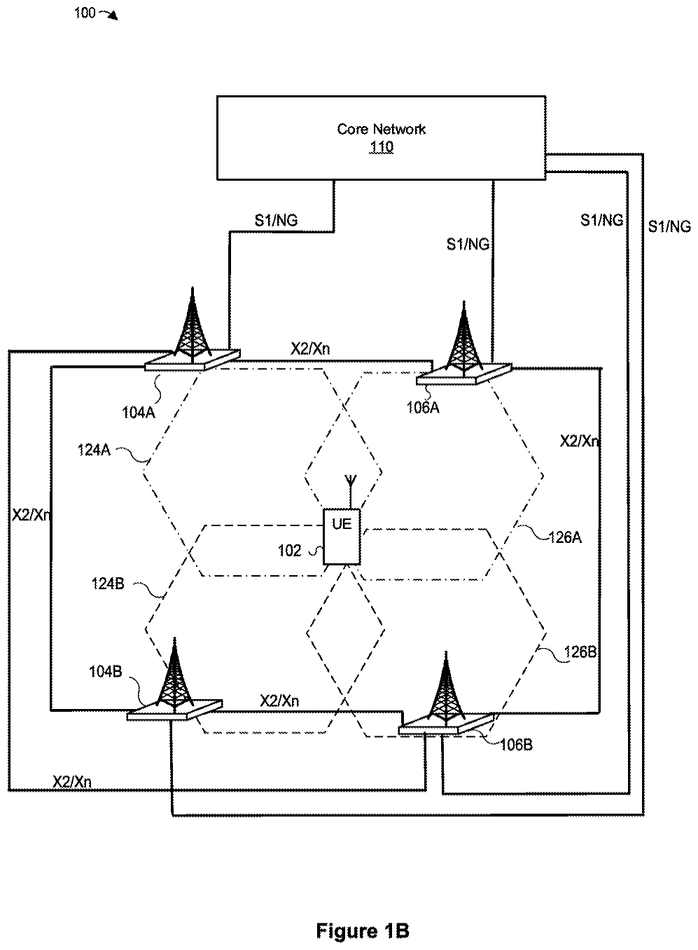

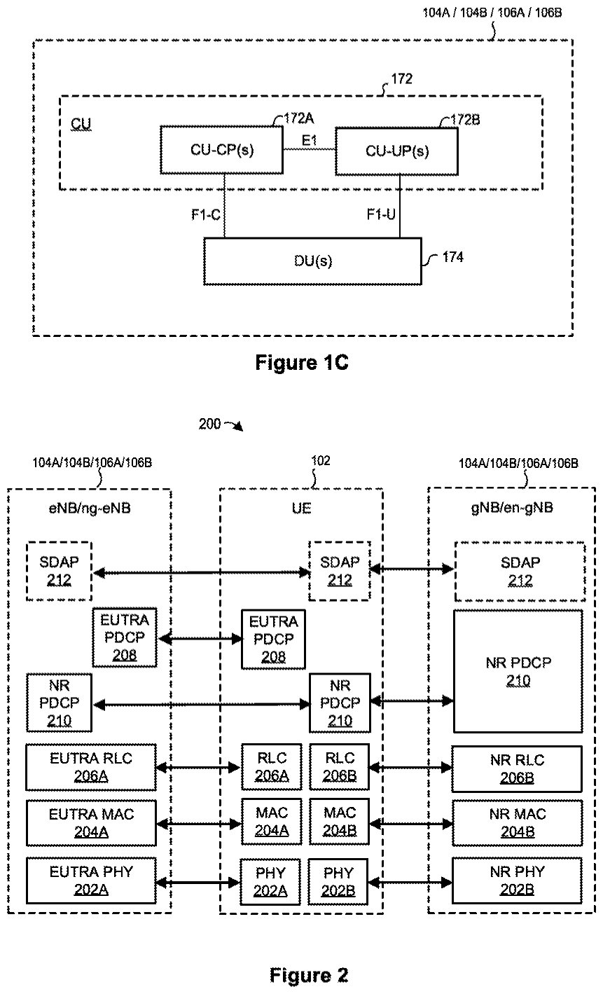

As discussed in detail below, network nodes of a radio access network (RAN) in communication with a UE can implement the techniques disclosed herein to manage multi-radio dual connectivity (MR-DC) in scenarios involving distributed base station architectures and scenarios involving suspending and resuming dual connectivity, for example. Prior to discussing these techniques, example communication systems which can implement these techniques are considered with reference to FIGS. 1A-1B.

FIG. 1A depicts an example wireless communication system 100 that includes a UE 102, a base station (BS) 104A, a base station 106A, and a core network (CN) 110. The base stations 104A and 106A can operate in a RAN 105 connected to the same core network (CN) 110. The CN 110 can be implemented as an evolved packet core (EPC) 111 or a fifth generation (5G) core (5GC) 160, for example.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104A supports a cell 124, and the base station 106A supports a cell 126A. The base station 106A may additionally support a cell 125A. The cells 124A and 126A can partially overlap, so that the UE 102 can communicate in DC with the base station 104A and the base station 106A operating as a master node (MN) and a secondary node (SN), respectively. The cells 125A and 126A can partially overlap, so that the UE 102 can communicate in CA or DC with the base station 106A operating as a master node (MN) and a secondary node (SN), respectively. To directly exchange messages during DC scenarios and other scenarios discussed below, the base station 104A (also referred to herein as MN 104) and the base station 106A (also referred to herein as SN 106) can support an X2 or Xn interface. In general, the CN 110 can connect to any suitable number of base stations supporting 5G new radio (NR) cells and/or EUTRA cells.

As illustrated in FIG. 1A, the base station 104A supports a cell 124A, and the base station 106A supports a cell 126A. The cells 124A and 126A can partially overlap, so that the UE 102 can communicate in DC with the base station 104A and the base station 106A operating as a master node (MN) and a secondary node (SN), respectively. To directly exchange messages during DC scenarios and other scenarios discussed below, the MN 104A and the SN 106A can support an X2 or Xn interface. In general, the CN 110 can connect to any suitable number of base stations supporting NR cells and/or EUTRA cells. An example configuration in which the EPC 110 is connected to additional base stations is discussed below with reference to FIG. 1B.

The base station 104A is equipped with processing hardware 130 that can include one or more general-purpose processors such as CPUs and non-transitory computer-readable memory storing machine-readable instructions executable on the one or more general-purpose processors, and/or special-purpose processing units (e.g., an application-specific integrated circuit (ASIC) or a digital signal processor (DSP)). The processing hardware 130 in the example implementation in FIG. 1A includes an MN RRC controller 132 that is configured to manage or control RRC configurations and RRC procedures. For example, the MN RRC controller 132 can be configured to support RRC messaging associated with RRC connection establishment procedures, RRC connection resume procedures, RRC connection reestablishment procedures, RRC reconfiguration procedures, procedures for MR-DC, CA, or other suitable functionalities, and/or to support the necessary operations when the base station 104A operates as an MN, as described below. The processing hardware 130 can include an SCG controller 134 configured to manage or control deactivation and/or activation of an SCG between the UE 102 and an SN.

The base station 106A is equipped with processing hardware 140 that can also include one or more general-purpose processors such as CPUs and non-transitory computer-readable memory storing machine-readable instructions executable on the one or more general-purpose processors, and/or special-purpose processing units (e.g., an ASIC or a DSP). The processing hardware 140 in an example implementation includes an SN RRC controller 142 configured to manage or control RRC configurations and RRC procedures. The processing hardware 140 can include an SCG controller 144 configured to manage, control or perform deactivation and/or activation of an SCG between the UE 102 and an SN. In general, because a base station can operate as an MN or an SN in different scenarios, the RRC controllers 132 and 142 can implement similar sets of functions and each support both MN and SN operations.

Still referring to FIG. 1A, the UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in the example implementation of FIG. 1A includes a UE RRC controller 152 that is configured to manage or control RRC configurations and/or RRC procedures. For example, the UE RRC controller 152 can be configured to support RRC messaging associated with RRC connection establishment procedures, RRC connection resume procedures, RRC connection reestablishment procedures, and/or procedures for MR-DC, CA, or other suitable functionalities, in accordance with any of the implementations described below. The processing hardware 150 can include an SCG controller 154 configured to manage, control or perform deactivation and/or activation of an SCG between the UE 102 and an SN.

More particularly, the RRC controllers 132, 142, and 152 can implement at least some of the techniques discussed below (with reference to various messaging and flow diagrams) to manage RRC configurations. The SCG controllers 134, 144, and 154 can implement at least some of the techniques discussed below (with reference to various messaging and flow diagrams) to manage SCG deactivation and/or activation.

In operation, the UE 102 can use a radio bearer (e.g., a DRB or an SRB) that at different times terminates at the MN 104A or the SN 106A. The UE 102 can receive a radio bearer configuration configuring the radio bearer from the MN 104A or the SN 106A. The UE 102 can apply one or more security keys when communicating on the radio bearer, in the uplink (from the UE 102 to a base station) and/or downlink (from a base station to the UE 102) direction. The UE 102 in some cases can use different RATs to communicate with the base stations 104A and 106A. Although the examples below may refer to specific RAT types, 5G NR or EUTRA, in general the techniques of this disclosure also can apply to other suitable radio access and/or core network technologies.

FIG. 1B depicts an example wireless communication system 100 in which communication devices can implement these techniques. The wireless communication system 100 includes a UE 102, a base station 104A, a base station 104B, a base station 106A, a base station 106B and a core network (CN) 110. The UE 102 initially connects to the base station 104A. The base stations 104B and 106B may have similar processing hardware as the base station 106A. The UE 102 initially connects to the base station 104A or 106A.

As illustrated in FIG. 1B, the base station 104A supports a cell 124A, the base station 104B supports a cell 124B, the base station 106A supports a cell 126A, and the base station 106B supports a cell 126B. The cells 124A and 126A can partially overlap, as can the cells 124A and 126B, so that the UE 102 can communicate in DC with the base station 104A (operating as an MN) and the base station 106A (operating as an SN) and, upon completing an SN change, with the base station 104A (operating as MN) and the base station 106B (operating as an SN). More particularly, when the UE 102 is in DC with the base station 104A and the base station 106A or 106B, the base station 104A operates as an MeNB, an Mng-eNB, or an MgNB, and the base station 106A or 106B operates as an SgNB or an Sng-eNB. The cells 124A and 124B can partially overlap, so that the UE 102 can communicate with the base station 104A and, upon completing a handover, with the base station 104A.

In general, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core network or 5G NR-6G DC.

FIG. 1C depicts an example, distributed or disaggregated implementation of any one or more of the base stations 104A, 104B, 106A, 106B. In this implementation, the base station 104A, 104B, 106A, or 106B includes a central unit (CU) 172 and one or more DUs 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 106A) operates as an MN or an SN. The process hardware can also include a physical layer controller configured to manage or control one or more physical layer operations or procedures.

In some implementations, the CU 172 can include a logical node CU-CP 172A that hosts the control plane part of the Packet Data Convergence Protocol (PDCP) protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. The CU-CP 172A can be connected to one or more DU 174s through an F1-C interface. The CU-UP 172B can be connected to one or more DU 174 through the F1-U interface under the control of the same CU-CP 172A. In some implementations, one DU 174 can be connected to multiple CU-UP 172B under the control of the same CU-CP 172A. In such implementations, the connectivity between a CU-UP 172B and a DU 174 is established by the CU-CP 172A using Bearer Context Management functions.

FIG. 2 illustrates, in a simplified manner, an example protocol stack 200 according to which the UE 102 can communicate with an eNB/ng-eNB or a gNB (e.g., one or more of the base stations 104A, 104B, 106A, 106B).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to a NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2). The UE 102, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

In scenarios where the UE 102 operates in EN-DC with the base station 104 operating as an MeNB and the base station 106A operating as an SgNB, the wireless communication system 100 can provide the UE 102 with an MN-terminated bearer that uses EUTRA PDCP sublayer 208, or an MN-terminated bearer that uses NR PDCP sublayer 210. The wireless communication system 100 in various scenarios can also provide the UE 102 with an SN-terminated bearer, which uses only the NR PDCP sublayer 210. The MN-terminated bearer can be an MCG bearer, a split bearer, or a MN-terminated SCG bearer. The SN-terminated bearer can be an SCG bearer, a split bearer, or a SN-terminated MCG bearer. The MN-terminated bearer can be an SRB (e.g., SRB1 or SRB2) or a DRB. The SN-terminated bearer can be an SRB or a DRB.

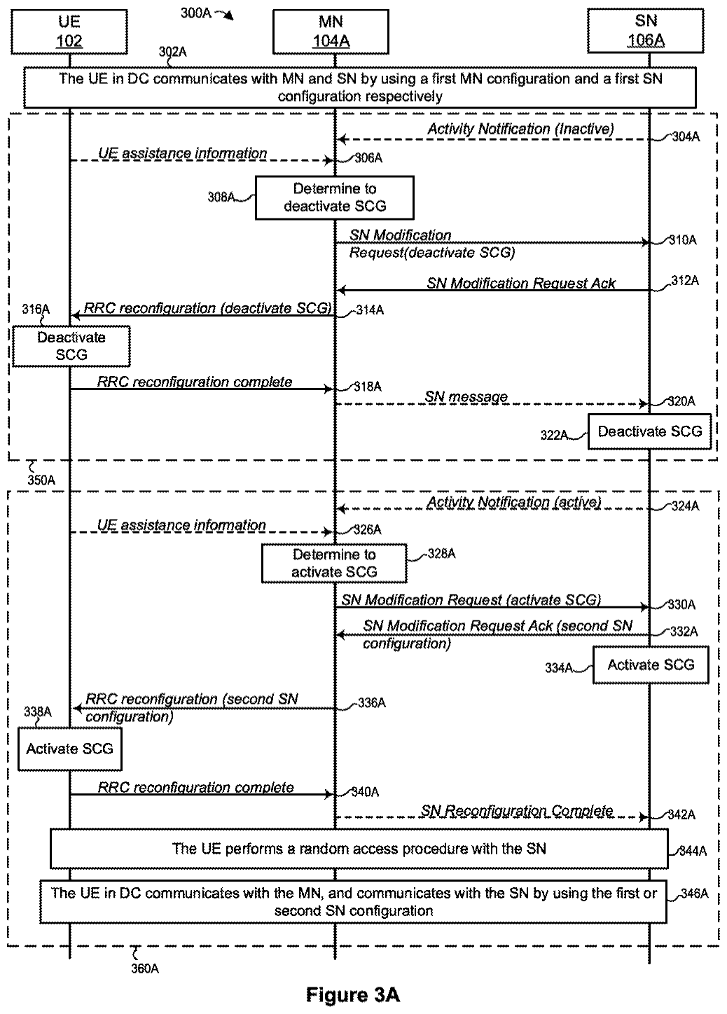

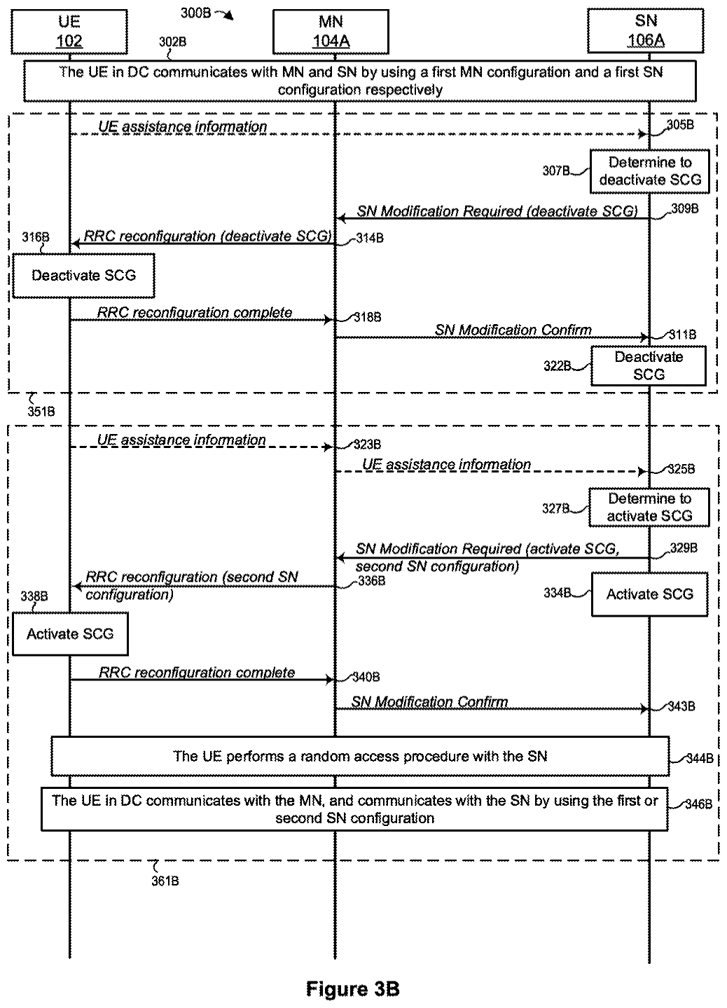

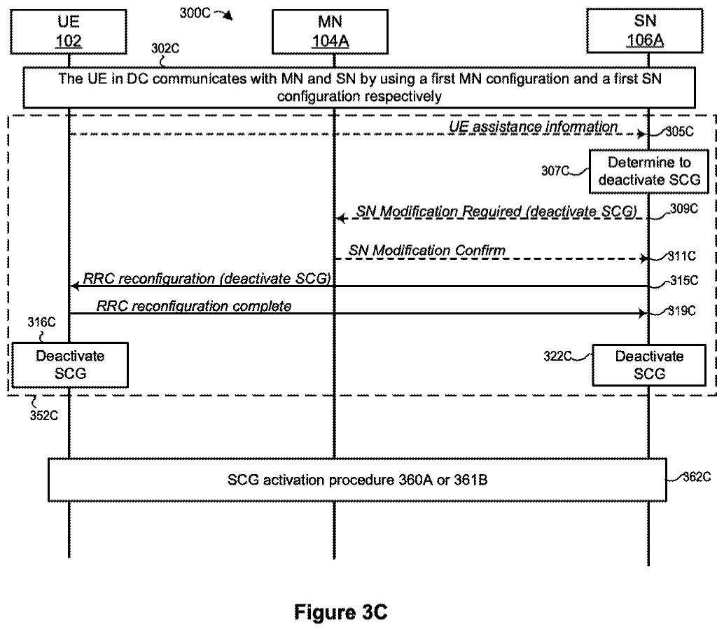

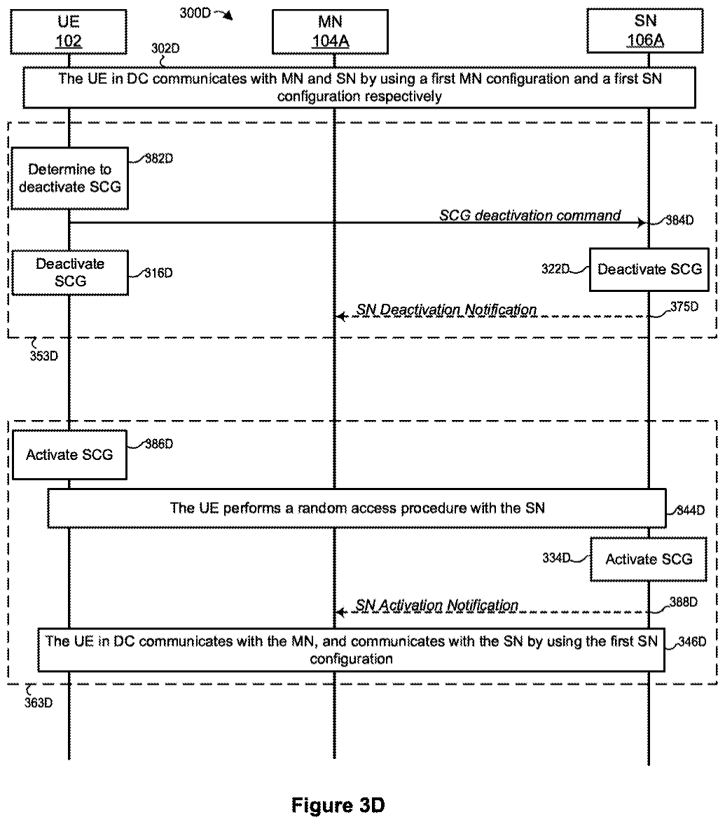

Next, several example scenarios in which the base stations operating in the system of FIG. 1A deactivate and reactivate an SCG between the UE 102 and an SN of the RAN 105 are discussed with reference to FIGS. 3A-7. Generally speaking, events in FIGS. 3A-7 that are similar are labeled with similar reference numbers (e.g., event 316A is similar to events 316B-D, 416A-D, and 516A-B; event 336A is similar to events 636 and 736), with differences discussed below where appropriate. With the exception of the differences shown in the figures and discussed below, any of the alternative implementations discussed with respect to a particular event (e.g., for messaging and processing) may apply to events labeled with similar reference numbers in other figures.

Referring first to FIG. 3A, in a scenario 300A, the base station 104A operates as an MN, and the base station 106A operates as an SN. Initially, the UE 102 in DC communicates 302A uplink (UL) PDUs and/or downlink (DL) PDUs with the MN 104A and with SN 106A in accordance with a first MN configuration and a first SN configuration, respectively. In some implementations, the UE 102 in DC can communicate 302A UL PDUs and/or DL PDUs via radio bearers which can include SRBs and/or DRBs. The MN 104A and/or the SN 106A can configure the radio bearers to the UE 102. The UE 102 in DC communicates 302A UL PDUs and/or DL PDUs with the SN 106A on an SCG that the SN 106A configures for communication with the UE 102. The UE 102 in DC communicates with the MN 104A on an MCG and with the SN 106A on an SCG. In the first MN configuration, the MN 104A configures the MCG which includes at least one serving cell operated by the MN 104A. In the first SN configuration, the SN 106A configures the SCG which includes at least one serving cell operated by the SN 106A. In some implementations, the first MN configuration includes multiple configuration parameters and the UE 102 receives the configuration parameters in one or more RRC messages from the MN 104A. In other implementations, the first SN configuration includes multiple configuration parameters and the UE 102 receives the configuration parameters in one or more RRC messages from the SN 106A, e.g., via the MN 104A or on an SRB (e.g., SRB3) that the MN 104A or SN 106A configures to exchange RRC messages between the UE 102 and the SN 106A.

At a later time, the MN 104A determines 308A to deactivate the SCG for communication with the UE 102. In some implementations, the MN 104A can determine that data inactivity on the SCG exists for the UE 102 and, in response, determine 308A to deactivate the SCG for the UE 102. In one implementation, the MN 104A determines that data inactivity exists for the UE 102 based on a message for the UE 102 that the MN 104A receives from the SN 106A. For example, the SN 106A may detect data inactivity for the UE 102, and in response send 304A an Activity Notification message with an inactive indication for the UE 102 to the MN 104A. The MN 104A can then determine that data inactivity exists for the UE 102 based on the received Activity Notification message. In another implementation, if the MN 104A has not received data packets to be sent to the UE 102 via the SN 106A for a predetermined time period, the MN 104A may detect data inactivity exists for the UE 102.

In other implementations, the MN 104A determines to deactivate the SCG for the UE 102 based on a UE preference that the MN 104A receives from the UE 102. For example, the UE 102 transmits 306A UE assistance information (e.g., UEAssistanceInformation message) to the MN 104A, indicating the UE (temporarily) prefers single connectivity to save power or due to overheating. The MN 104A determines 308A to deactivate the SCG for the UE 102 in response to the UE assistance information received at event 306A.

In response to the determination 308A, the MN 104A sends 310A to the SN 106A an SN Modification Request message that deactivates the SCG for the UE 102. In response to the SN Modification Request message, the SN 106A sends 312A an SN Modification Request Acknowledge message to the MN 104A. In some implementations, the MN 104A includes an indication (e.g., a field or an information element (IE)) in the SN Modification Request Acknowledge message to cause the SN 106A to deactivate the SCG.

In response to the determination 308A, after the MN 104A transmits 308A the SN Modification Request message or after the MN 104A receives 312A the SN Modification Request Acknowledge message, the MN 104A transmits 314A an RRC reconfiguration message to cause the UE 102 to deactivate the SCG. In response to the RRC reconfiguration message, the UE 102 deactivates 316A the SCG for communication with the SN 106A and transmits 318A an RRC reconfiguration complete message to the MN 104A. After deactivating the SCG, the UE 102 retains the radio connection with the MN 104A. After receiving the RRC reconfiguration complete message, the MN 104A can send 320A an SN message (e.g., SN Reconfiguration Complete message) to the SN 106A to indicate that the UE 102 has deactivated the SCG. In some implementations, the MN 104A can generate an indication (e.g., a field or an information element (IE)) to deactivate the SCG and include the indication in the RRC reconfiguration message the MN 104A transmits 314A.

The SN 106A can deactivate 322A the SCG for communication with the UE 102 in response to the SN Modification Request message, after transmitting the SN Modification Request Acknowledge message or receiving the SN message. For example, the SN 106A can deactivate 322A the SCG after receiving the SN message, or after a predetermined time after receiving 310 the SN Modification Request message, such that the SN 106A does not deactivate 322A the SCG at the SN 106A until the UE 102 deactivates 316A the SCG at the UE 102. The events 304A, 306A, 308A, 310A, 312A, 314A, 316A, 318A, 320A and 322A are collectively referred to in FIG. 3A as an SCG deactivation procedure 350A.

In some implementations, the SN 106A suspends lower layers (e.g., PHY 202A/202B, MAC 204A/204B, and/or RLC 206A/206B) for communication with the UE 102 after or upon deactivating the SCG. While suspending the lower layers, the SN 106A in one implementation does not transmit downlink transmissions to the UE 102 by the lower layers. While suspending the lower layers, the SN 106A in another implementation does not receive uplink transmissions from the UE 102 by the lower layers. Similarly, the UE 102 in some implementations suspends lower layers (e.g., PHY 202A/202B, MAC 204A/204B, and/or RLC 206A/206B) for communication with the SN 106A to deactivate the SCG. While suspending the lower layers, the UE 102 in one implementation does not transmit uplink transmissions to the SN 106A by the lower layers. While suspending the lower layers, the UE 102 in another implementation does not receive downlink transmissions from the SN 106A by the lower layers. For example, the downlink transmissions can include PDUs (e.g., MAC PDUs or RLC PDUs), downlink control information (DCI) with a cyclic redundancy check (CRC) scrambled with a cell radio network temporary identifier (C-RNTI), and/or reference signals (e.g., channel state information reference signal (CSI-RS)). In another example, the uplink transmissions can include PDUs (e.g., MAC PDUs or RLC PDUs), channel state information (CSI), physical uplink control channel (PUCCH), and/or sounding reference signal (SRS).

In some implementations, the MN 104A can include an indication deactivating the SCG in the SN Modification Request message that the MN 104A transmits 310A. In other implementations, the MN 104A can include an indication suspending lower layers in the SN Modification Request message that the MN 104A transmits 310A to deactivate the SCG. In this case, the MN 104A may or may not include the indication deactivating the SCG in the SN Modification Request message that the MN 104A transmits 310A.

With continued reference to FIG. 3A, upon receiving 314A the RRC reconfiguration message or after deactivating the SCG, the UE 102 may retain the first SN configuration (or retain some configurations in the first SN configuration).

After deactivating the SCG, the MN 104A can determine 328A to activate the SCG for communication with the UE 102. In some implementations, the MN 104A can determine that data activity on the SCG exists for the UE 102 and, in response, determine 328A to activate the SCG for the UE 102. For example, the MN 104A determines that data activity exists for the UE 102 based on a message for the UE 102 that the MN 104A receives from the SN 106A. For example, the SN 106A may detect data activity for the UE 102, and in response send 324A an Activity Notification message with an active indication for the UE 102 to the MN 104A. The MN 104A can then determine that data activity exists for the UE 102 based on the received Activity Notification message. In some implementations, the SN 106A may receive data packets for the UE 102 from CN 110 so that the SN 106A may detect data activity for the UE 102.

In other implementations, the MN 104A receives data packets that the MN 104A will send to the UE 102 via the SN 106A, so that the MN 104A may determine to activate the SCG in response to receiving the data packets. The MN 104A can transmit the data packets to the UE 102 via the MCG. In yet other implementations, the MN 104A receives data packets for the UE 102 from the SN 106A, which causes the MN 104A determine to activate the SCG. The MN 104A can transmit the data packets to the UE 102 via the MCG.

In yet other implementations, the MN 104A determines to activate the SCG for the UE 102 based on a UE preference that the MN 104A receives from the UE 102. For example, the UE 102 send 326A UE assistance information (e.g., UEAssistanceInformation message) indicating the UE 102 (temporarily) prefers dual connectivity or has data to transmit on the SCG. The MN 104A determines 328A to activate the SCG for the UE 102 in response to the UE assistance information received at event 326A.

In yet other implementations, the MN 104A determines to activate the SCG for the UE 102 based on one or more measurement results received from the UE. If measurement result(s) for cell 126A are above a first threshold and/or measurement result(s) for cell 125A are below a second threshold, the MN 104A can determine to activate the SCG for the UE 102. Alternatively, the MN 104A refrains from activating the SCG even though measurement result(s) for cell 126A are above a first threshold and/or measurement result(s) for cell 125A (i.e., the current PSCell) are below a second threshold.

In response to the determination 328A, the MN 104A sends 330A to the SN 106A an SN Modification Request message which activates the SCG for the UE 102. In response to 330A the SN Modification Request message, the SN 106A sends 332A an SN Modification Request Acknowledge message to the MN 104A and activates 334A the SCG. In some implementations, the SN 106A can include a second SN configuration in the 332A SN Modification Request Acknowledge message. More specifically, the SN 106A includes, in the second SN configuration, random access configuration(s) for the UE 102 to perform a random access procedure with the SN 106A. In other implementations, the SN 106A does not include an SN configuration in the SN Modification Request Acknowledge message the SN transmits 332A.

In some implementations, the MN 104A does not include the indication to deactivate the SCG in the SN Modification Request message the MN 104A transmits 330A to cause the SN 106A to activate the SCG. In other implementations, the MN 104A generates an indication to activate the SCG and includes the indication in the SN Modification Request message the MN 104A transmits 330A to cause the SN 106A to activate the SCG. In yet other implementations, the MN 104A generates an indication to resume lower layers and includes the indication in the SN Modification Request message the MN 104A transmits 330A to cause the SN 106A to activate the SCG. In this case, the MN 104A may or may not include the indication activating the SCG in the SN Modification Request message the MN 104A transmits 330A.

In response to the determination 328A, after the MN 104A transmits 330A the SN Modification Request message or after the MN 104A receives 332A the SN Modification Request Acknowledge message, the MN 104A transmits 336A an RRC reconfiguration message to cause the UE 102 to activate the SCG. In response to the RRC reconfiguration message, the UE 102 activates 338A the SCG for communication with the SN 106A and transmits 340A an RRC reconfiguration complete message to the MN 104A. After receiving 340A the RRC reconfiguration complete message, the MN 104A can send 342A an SN Reconfiguration Complete message to the SN 106A to indicate that the UE 102 has activated the SCG. As discussed below, upon activating 338A the SCG, the UE 102 can communicate with the SN 106A using a stored SN configuration for the SN 106A, or using a second SN configuration that the UE 102 receives 336A from the MN 104A.

If the MN 104A receives the second SN configuration, the MN 104A includes the second SN configuration in the RRC reconfiguration message the MN 104A transmits 336A. In some implementations, the MN 104A can include an indication to activate the SCG in the RRC reconfiguration message the MN 104A transmits. In other implementations, the MN 104A does not include an indication to activate the SCG in the RRC reconfiguration message the MN 104A transmits 336A.

In some implementations, the UE 102 includes, in the RRC reconfiguration complete message the UE 102 transmits 340A, a second RRC reconfiguration complete message responding to receiving the second SN configuration. The MN 104A can include the second RRC reconfiguration complete message in the SN Reconfiguration Complete message so that the SN 106A can receive the second RRC reconfiguration complete message. If the SN 106A is a gNB, the second RRC reconfiguration complete message is an RRCReconfigurationComplete message. If the SN 106A is an ng-eNB, the second RRC reconfiguration complete message is an RRCConnectionReconfigurationComplete message.

At some point after receiving 336A the RRC reconfiguration message or in response to the 336A the RRC reconfiguration message, the UE 102 can perform 344A a random access procedure on cell 126A with the SN 106A to activate the SCG with the SN 106A. In some implementations, the UE 102 performs the random access procedure using one or more random access configurations in the second SN configuration. In other implementations, the UE 102 preforms the random access procedure using one or more random access configurations that the UE 102 received from the SN 106A before activating or deactivating the SCG.

After the UE 102 successfully completes the random access procedure on the cell 126A with the SN 106A, the UE 102 can communicate 346A data (user-plane data and/or control-plane data) in DC with both the MN 104A and the SN 106A through the cell 124A and cell 126A respectively. Having identified the UE 102 in the random access procedure, the SN 106A can communicate 346A data (user-plane data or control-plane data) with the UE 102 in accordance with the first SN configuration or the second SN configuration. In some implementations, the SN 106A can include new configuration parameters for the SCG in the second SN configuration. The UE 102 uses the new configuration parameters to communicate 346A data (user-plane data and/or control-plane data) with the SN 106A after activating the SCG. For example, the new configuration parameters can change PSCell, modify the current PSCell or a SCell, release a SCell, or add a new SCell. In another example, the new configuration parameters can include configuration parameters for operation of PHY 202A/202B, MAC 204A/204B or RLC 206A/206B. In another implementations, the SN 106A can indicate, in the second SN configuration, to release configuration parameter(s) included in the first SN configuration. Thus, the UE 102 releases the configuration parameter(s) and does not use the released configuration parameter(s) to communicate 346A data (user-plane data and/or control-plane data) with the SN 106A after activating the SCG. If the RRC reconfiguration message that the UE 102 receives 336A does not include an SN configuration, the UE 102 communicates 346A data (user-plane data and/or control-plane data) with the SN 106A using the first SN configuration.

The events 324A, 326A, 328A, 330A, 332A, 334A, 336A, 338A, 340A, 342A, 344A, and 346A are collectively referred to in FIG. 3A as an SCG activation procedure 360A.

The random access procedure can be a four-step random access procedure or a two-step random access procedure, for example. In different implementations and/or scenarios, the random access procedure may be a contention-based random access procedure or a contention-free random access procedure. In some implementations and/or scenarios, the UE 102 may include a UE identifier known by the SN 106A in a “message 3” of a four-step random access procedure, or in a message A of the two-step random access procedure, so that the SN 106A can identify the UE 102 using the UE identifier. In some implementations, the UE identifier is a radio network temporary identifier (RNTI) (e.g., a C-RNTI) allocated by the SN 106A in the first or second SN configuration. In other implementations, the SN 106A identifies the UE 102 based on a dedicated random access preamble that the SN 106A receives from the UE 102 during the random access procedure. The SN 106A can allocate the dedicated random access preamble in the second SN configuration.

In some implementations, the SN 106A activates 334A the SCG after or upon performing 344A the random access procedure with the UE 102. For example, the SN 106A can activate 334A the SCG in response to connecting to the UE 102 during the random access procedure. The SN 106A can determine that the UE 102 connects with the SN 106A in response to identifying the UE 102 during the random access procedure (e.g., based on a UE identifier or a dedicated random access preamble that the SN 106A receives from the UE 102 during the random access procedure).

In some implementations, the SN 106A resumes the lower layers (e.g., PHY 202A/202B, MAC 204A/204B, and/or RLC 206A/206B) for communication with the UE 102 after activating the SCG. After resuming the lower layers, the SN 106A in one implementation transmits downlink transmissions to the UE 102 by the lower layers. After resuming the lower layers, the SN 106A in another implementation receives uplinks transmissions from the UE 102 by the lower layers. Similarly, the UE 102 in some implementations resumes the lower layers (e.g., PHY 202A/202B, MAC 204A/204B, and/or RLC 206A/206B) for communication with the SN 106A after activating the SCG. After resuming the lower layers, the UE 102 in one implementation transmits uplink transmissions to the SN 106A by the lower layers. After resuming the lower layers, the UE 102 in another implementation receives downlink transmissions from the SN 106A by the lower layers. Example of the downlink transmissions are as described above.

In some implementations, the SN 106A resets (or re-establishes) at least one lower layer (e.g., PHY 202A/202B, MAC 204A/204B, and/or RLC 206A/206B) after deactivating 322A or activating 334A the SCG. Upon resetting the PHY 202A/202B or MAC 204A/204B, the SN 106A can set NDI value(s), associated to HARQ process(es) in the PHY 202A/202B or MAC 204A/204B that the SN 106A used to communicate with the UE 102, to initial values. For example, if SN 106A used the HARQ process(es) to receive transmissions from the UE 102, the SN 106A sets the NDI value(s) to an initial value upon resetting the PHY 202A/202B or MAC 204A/204B. In another example, if SN 106A used the HARQ process(es) to transmit transmissions to the UE 102, the SN 106A sets the NDI value(s) to an initial value of 0 or 1 upon resetting the PHY 202A/202B or MAC 204A/204B. Upon resetting the PHY 202A/202B or MAC 204A/204B, the SN 106A can reset beam failure instance indication counter(s) (e.g., set the counter(s) to initial value(s) such as 0 or a static value), and/or reset listen-before-talk (LBT) counter(s) (e.g., set the counter(s) to initial value(s) such as 0 or a static value). Upon re-establishing RLC 206A/206B, the SN 106A sets RLC variables in the RLC 206A/206B to initial values (e.g., 0 or a static value) specified in 3GPP specification 36.322/38.322.

Similarly, the UE 102 can reset (or re-establish) at least one lower layer (e.g., PHY 202A/202B, MAC 204A/204B, and/or RLC 206A/206B) after deactivating 316A or activating 338A the SCG. Upon resetting the PHY 202A/202B or MAC 204A/204B, the UE 102 sets NDI value(s) associated to HARQ process(es) in the PHY 202A/202B or MAC 204A/204B that the UE 102 used to communicate with the SN 106A to initial values. For example, if UE 102 used the HARQ process(es) to transmit transmissions to the SN 106A, the UE 102 sets the NDI value(s) to an initial value of 0 upon resetting the PHY 202A/202B or MAC 204A/204B. In another example, if UE 102 used the HARQ process(es) to receive transmissions from the SN 106A, the UE 102 flushes soft buffers for the HARQ process(es), and/or considers the next received transmission for a transport block as the very first transmission after activating the SCG, upon resetting the PHY 202A/202B or MAC 204A/204B. Upon resetting the PHY 202A/202B or MAC 204A/204B, the UE 102 can reset beam failure instance indication counter(s) (e.g., set the counter(s) to initial value(s) such as 0 or a static value), and/or reset listen-before-talk (LBT) counter(s) (e.g., set the counter(s) to initial value(s) such as 0 or a static value). Upon resetting MAC 204A/204B, the UE 102 can initialize variable Bj for logical channel(s) to zero for logical channel prioritization. Upon re-establishing RLC 206A/206B, the UE 102 sets RLC variables in the RLC 206A/206B to initial values (e.g., 0 or a static value) specified in 3GPP specification 36.322/38.322.

In other implementations, the SN 106A retains operating information in at least one lower layer (e.g., PHY 202A/202B, MAC 204A/204B, and/or RLC 206A/206B) for communication with the UE 102 after deactivating 322A the SCG. After activating 334A the SCG, the SN 106A can continue using the operating information in the at least one lower layer to communicate with the UE 102. For example, the operating information includes NDI values associated to HARQ processes in the PHY 202A/202B or MAC 204A/204B and/or RLC variables (i.e., values of the variables) in RLC 206A/206B that the SN 106A used to communicate with the UE 102. After deactivating 322A the SCG, the SN 106A can retain the NDI values and/or the RLC variables in RLC 206A/206B. The RLC variables are specified in 3GPP specification 36.322/38.322.

Similarly, the UE 102 retains operating information in at least one lower layer (e.g., PHY 202A/202B, MAC 204A/204B, and/or RLC 206A/206B) for communication with the SN 106A after deactivating 316A the SCG or suspending the lower layers. After activating 338A the SCG, the UE 102 can continue using the operating information in the at least one lower layer to communicate with the SN 106A. For example, the operating information includes NDI values associated to HARQ processes in the PHY 202A/202B or MAC 204A/204B and/or RLC variables (i.e., values of the variables) in RLC 206A/206B that the UE 102 used to communicate with the SN 106A. After deactivating 316A the SCG, the UE 102 can retain the NDI values and/or the RLC variables in RLC 206A/206B. The RLC variables are specified in 3GPP specification 36.322/38.322.

In some implementations, the SN 106A suspends PDCP 208/210 and/or SDAP 212 for communication with the UE 102 after deactivating 322A the SCG. Similarly, the UE 102 suspends PDCP 208/210 and/or SDAP 212 for communication with the SN 106A after deactivating 316A the SCG. In other implementations the SN 106A does not suspend PDCP 208/210 or SDAP 212 after deactivating 322A the SCG. Similarly, the UE 102 does not suspend PDCP 208/210 or SDAP 212 for communication with the SN 106A after deactivating 316A the SCG.

In some implementations, the SN 106A re-establishes (or resets) PDCP 208/210 or SDAP 212 after deactivating 322A or activating 334A the SCG. In other implementations, the SN 106A refrains from re-establishing (or resetting) PDCP 208/210 or SDAP 212 after deactivating 322A or activating 334A the SCG. In some implementations, the SN 106A sets PDCP variables TX_NEXT, RX_NEXT and/or RX_DELIV to initial values (e.g., 0 or a default or static value) after deactivating 322A or activating 334A the SCG. Similarly, the UE 102 sets PDCP variables TX_NEXT, RX_NEXT and/or RX_DELIV to initial values (e.g., 0 or a default or static value) after deactivating 316A or activating 338A the SCG. In some implementations, the SN 106A resets header compression/decompression protocol/context or data compression/decompression protocol/context after deactivating 316A or activating 334A the SCG. Similarly, the UE 102 resets header compression/decompression protocol/context or data compression/decompression protocol/context after deactivating 316A or activating 338A the SCG.

In other implementations, the SN 106A retains operating information in PDCP 208/210 or SDAP 212 for communication with the UE 102 after deactivating 322A the SCG. After activating 334A the SCG, the SN 106A can continue using the operating information to communicate with the UE 102. Similarly, the UE 102 retains operating information in PDCP 208/210 or SDAP 212 for communication with the SN 106 after deactivating 316A the SCG. After activating 338A the SCG, the UE 102 can continue using the operating information to communicate with the SN 106A. In some implementations, the operating information may include (values of) PDCP variables and/or quality of service (QoS) flow information. For example, the PDCP variables includes TX_NEXT, RX_NEXT and/or RX_DELIV specified in 3GPP specification 38.323. In another example, the QoS flow information includes an identity/identifier of a QoS flow, QoS flow to DRB mapping rule, and/or service data flow (SDF) to QoS flow mapping rule. In other implementations, the operating information may include header compression/decompression protocol/context or data compression/decompression protocol/context.

In some implementations, the SN 106A stops and/or resets a reordering timer (e.g., t-Reordering) upon deactivating 322A the SCG. The SN 106A can deliver all stored PDCP SDUs to an upper layer (e.g., SDAP) or CN 110 in ascending order of associated COUNT values after performing header decompression. Similarly, the UE 102 stops and/or resets a reordering timer (e.g., t-Reordering) upon deactivating 316A the SCG. The SN 106A can deliver all stored PDCP SDUs to an upper layer (e.g., SDAP) or CN 110 in ascending order of associated COUNT values after performing header decompression.

The operating information in a protocol layer (e.g., PHY 202A/202B, MAC 204A/204B, RLC 206A/206B, PDCP 208/210 or SDAP 212) may or may not include configuration parameters in an RRC message received from the RAN 105.

The MN 104A and the SN 106A can include the at least one interface ID of the UE 102, as discussed above, in the messages transmitted between the MN 104A and the SN 106A. For example, the MN 104A can include the interface ID(s) in the SN Modification Request messages the MN 104A transmits at events 310A and 330A, in the SN message the MN 104A transmits at event 320A, and in the SN Reconfiguration Complete message the MN 104A transmits at event 342A. The SN 106A can include the interface ID(s) in the SN Modification Request Acknowledge messages the SN 106A transmits at events 312A and 332A.

In some implementations, the RAN 105 (e.g., the MN 104A or the SN 106A) configures the UE 102 to transmit 302A UL PDUs of a DRB to the SN 106A on the SCG. In one implementation, the RAN 105 transmits to the UE 102 a first RRC message setting a primary path for the DRB to the SCG so that the UE 102 transmits 302A UL PDUs of the DRB on the SCG to the SN 106A. For example, the first RRC message can be an RRC reconfiguration message including a primary path configuration (e.g., primaryPath field) including a cell group identity (e.g., CellGroupId IE) of the SCG. In some implementations, the RAN 105 can set the primary path to the MCG in the RRC reconfiguration message the MN 104A transmits 314A, so that the UE 102 can transmit UL PDUs of the DRB to the MN 104A on the MCG after deactivating 316A the SCG. In the RRC reconfiguration message the MN 104A transmits 314A, the RAN 105 can include a primary path configuration (e.g., primaryPath field) including a cell group identity (e.g., CellGroupId IE) of the MCG. Alternatively, after determining 308A to deactivate the SCG, the RAN 105 can transmit to the UE 102 a second RRC message setting the primary path to the MCG. For example, the second RRC message can be an RRC reconfiguration message including a primary path configuration (e.g., primaryPath field) including a cell group identity (e.g., CellGroupId IE) of the MCG.

In other implementations, the RAN 105 does not change the primary path for the DRB after determining 308A to deactivate the SCG. In this case, the UE 102 in one implementation may switch the primary path from the SCG to the MCG by itself after deactivating 316A the SCG. Thus, the UE 102 can transmit UL PDUs of the DRB to the MN 104A on the MCG after deactivating 316A the SCG. In another implementation the UE 102 does not change the primary path to the MCG by itself after deactivating 316A the SCG. In this implementation, the UE 102 may transmit 326A the UE assistance information the MN 104A if the UE 102 has UL PDUs of the DRB to transmit after deactivating 316A the SCG.

In some implementations, the MN 104A can also include a second MN configuration in the RRC reconfiguration message the MN 104A transmits 336A, in which case, the UE 102 communicates 346A with the MN 104A using the second MN configuration. In some implementations, the MN 104A can include a radio bearer configuration (e.g., RadioBearerConfig IE) in the RRC reconfiguration message the MN 104A transmits 336A.

In some implementations, the MN 104A generates the second MN configuration as a delta MN configuration which augments only a portion of the first MN configuration. Accordingly, the UE 102 communicates 346A with the MN 104A using the delta MN configuration and the portion of the first MN configuration that is not augmented by the delta MN configuration. In other implementations, the MN 104A does not include a second MN configuration in the RRC reconfiguration message.

The first MN configuration can include multiple configuration parameters that configure radio resources for the UE 102 to communicate with the MN 104A via a PCell (e.g., the cell 124A or a cell other than cell 124) and zero, one, or more secondary cells (SCells) of the MN 104A. For example, the first MN configuration can include PHY configuration(s), MAC configuration(s), and/or RLC configuration(s). In another example, the first MN configuration can include one or more measurement configurations. The first MN configuration can include one or more radio bearer configurations configuring one or more radio bearers. The UE 102 may receive the multiple configuration parameters in one or more RRC messages from the MN 104A.

In some implementations, the MN configuration (i.e., the first MN configuration and/or the second MN configuration) includes configuration parameters in an RRCReconfiguration message, RRCReconfiguration-IEs, or the CellGroupConfig information element (IE) conforming to 3GPP TS 38.331. In one implementation, the MN configuration can be an RRCReconfiguration message, RRCReconfiguration-IEs, or the CellGroupConfig 1E conforming to 3GPP TS 38.331. In other implementations, the MN configuration can include configuration parameters in a RadioResourceConfigDedicated IE, RRCConnectionReconfiguration message, or RRCConnectionReconfiguration-IEs. In one implementation, the MN configuration can be a RadioResourceConfigDedicated IE, an RRCConnectionReconfiguration message, or an RRCConnectionReconfiguration-IEs conforming to 3GPP TS 36.331.

The SN configuration (e.g., the first SN configuration and/or the second SN configuration) can include multiple configuration parameters that configure radio resources for the UE 102 to communicate with the SN 106A via a PSCell (e.g., the cell 126A or a cell other than cell 126) and zero, one, or more SCells of the SN 106A. For example, the SN configuration can include PHY configuration(s), MAC configuration(s), and/or RLC configuration(s). The SN configuration may or may not include measurement configuration(s). In some implementations, the second SN configuration may or may not include one or more radio bearer configurations configuring one or more radio bearers. In some implementations, the second SN configuration can be a complete and self-contained configuration (i.e. a full configuration). The UE 102 can use the full SN configuration to communicate with the SN 106A without relying on the first SN configuration. In other implementations, the SN 106A generates the second SN configuration as a delta SN configuration which augments only a portion of the first SN configuration. Accordingly, the UE 102 communicates 346A with the SN 106A using the delta SN configuration and the portion of the first SN configuration that is not augmented by the delta SN configuration. In yet other implementations, the SN 106A includes only the random access configuration(s) in the second SN configuration so that the UE 102 communicates 346A with the SN 106A using the first SN configuration.

In some implementations, the SN configuration includes configuration parameters in an RRCReconfiguration message, RRCReconfiguration-IEs, or a CellGroupConfig IE conforming to 3GPP TS 38.331. In one implementation, the SN configuration can be an RRCReconfiguration message, RRCReconfiguration-IEs, or a CellGroupConfig IE conforming to 3GPP TS 38.331. In other implementations, the SN configuration can include configuration parameters in an SCG-ConfigPartSCG-r12 IE. In some implementations, the SN configuration can be an RRCConnectionReconfiguration message, RRCConnectionReconfiguration-IEs, or a ConfigPartSCG-r12 IE conforming to 3GPP TS 36.331.

If the MN 104A is a gNB, the RRC reconfiguration message and the RRC reconfiguration complete message are RRCReconfiguration message and RRCReconfigurationComelete message, respectively. If the MN 104A is an eNB or ng-eNB, the RRC reconfiguration message and the RRC reconfiguration complete message are RRCConnectionReconfiguration message and RRCConnectionReconfigurationComelete message, respectively.

Referring next to FIG. 3B, a scenario 300B, the base station 104A operates as an MN and the base station 106A operates as an SN. The scenario 300B is generally similar to the scenario 300A, but with the SN 106A, rather than the MN 104A, determining to deactivate the SCG and activate the SCG. As mentioned above, events in the scenario 300B similar to those discussed above with respect to the scenario 300A are labeled with similar reference numbers (e.g., with event 302A of FIG. 3A corresponding to event 302B of FIG. 3B). With the exception of the differences shown in FIG. 3B and the differences described below, any of the alternative implementations discussed above with respect to the scenario 300A (e.g., for messaging and processing) may apply to the scenario 300B.

After event 302B, the SN 106A determines 307B to deactivate the SCG for communication with the UE 102. In some implementations, the SN 106A can determine that data inactivity on the SCG exists for the UE 102 and, in response, determine 307B to deactivate the SCG for the UE 102. In one implementation, the SN 106A has neither received data packets to be sent to the UE 102 from the CN 110 nor received data packets from the UE 102 for a predetermined time period, so that the SN 106A may detect data inactivity exists for the UE 102.

In other implementations, the SN 106A determines 307B to deactivate the SCG for the UE 102 based on a UE preference that the SN 106A receives from the UE 102 e.g., via the MN 104A or on an SRB (e.g., SRB3) that the MN 104A or SN 106A configures to exchange RRC messages between the UE 102 and the SN 106A. For example, the UE 102 sends 305B UE assistance information (e.g., UEAssistanceInformation message) to the SN 106A, indicating the UE (temporarily) prefers single connectivity to save power or due to overheating. The SN 106A determines 307B to deactivate the SCG for the UE 102 in response to the UE assistance information received at event 305B. In some implementations, the SN 106A receives 305B the UE assistance information from the UE 102 via the MN 104A.

In response to the determination 307B, the SN 106A sends 309B to the SN 106A an SN Modification Required message that requests to deactivate the SCG for the UE 102. In response to the request to deactivate the SCG, the MN 104A transmits 314B an RRC reconfiguration message to the UE 102, similar to event 314A. The UE 102 deactivates 316B the SCG and transmits 318B an RRC reconfiguration complete message to the MN 104A in response to the RRC reconfiguration message the UE 102 receives 314B, similar to events 316A and 318A respectively. After receiving 318B the RRC reconfiguration complete message, the MN 104A sends 311B an SN Modification Confirm message to the SN 106A to indicate that the UE 102 has deactivated the SCG, in response to the SN Modification Required message.

In some implementations, the SN 106A includes an indication (e.g., a field or an information element (IE)) to deactivate the SCG in the 309B SN Modification Required message to cause the MN 104A to transmit 314B the RRC reconfiguration message to deactivate the SCG. The SN 106A deactivates 322B the SCG after determining 307B to deactivate the SCG. In some implementations, the SN 106A deactivates 322B the SCG after receiving 311B the SN Modification Confirm message. The events 305B, 307B, 309B, 311B, 314B, 316B, 318B, 320B and 322B are collectively referred to in FIG. 3B as an SCG deactivation procedure 351B.

After deactivating 322B the SCG or receiving 311B the SN Modification Confirm message, the SN 106A can determine 327B to activate the SCG for communication with the UE 102. In some implementations, the SN 106A can determine that data activity on the SCG exists for the UE 102 and, in response, determine 327B to activate the SCG for the UE 102. In one implementation, if the SN 106A has received data packets to be sent to the UE 102 from the CN 110, the SN 106A can detect data activity exists for the UE 102.

In other implementations, the SN 106A determines 327B to activate the SCG for the UE 102 based on UE preference that the SN 106A receives from the UE 102 via the MN 104A. For example, the UE 102 sends 323B UE assistance information (e.g., UEAssistanceInformation message) to the MN 104A, indicating the UE 102 (temporarily) prefers dual connectivity or has data to transmit on the SCG. In turn, the MN 104A sends 325B the UE assistance information to the SN 106A. The SN 106A determines 327B to activate the SCG for the UE 102 in response to the UE assistance information received at event 325B.

In yet other implementations, the SN 106A determines 327B to activate the SCG for the UE 102 based on one or more measurement results received from the UE via the MN 104A. If measurement result(s) for cell 126A are above a first threshold and/or measurement result(s) for cell 125A (i.e., the current PSCell) are below a second threshold, the SN 106A can determine to activate the SCG for the UE 102. Thus, the SN 106A can change the PSCell from the cell 125A to the cell 126A by activating 334B the SCG. Alternatively, the SN 106A refrains from activating the SCG even though measurement result(s) for cell 126A are above a first threshold and/or measurement result(s) for cell 125A (i.e., the current PSCell) are below a second threshold.

In response to the determination 327B, the SN 106A sends 329B to the SN 106A an SN Modification Required message that requests to activate the SCG for the UE 102. In response to the request to activate the SCG, the MN 104A transmits 336B an RRC reconfiguration message to the UE 102, similar to event 336A. The UE 102 activates 338B the SCG and transmits 340B an RRC reconfiguration complete message to the MN 104A in response to the RRC reconfiguration message the UE 102 receives 336B, similar to events 338A and 340A respectively. After receiving 340B the RRC reconfiguration complete message, the MN 104A sends 343B an SN Modification Confirm message to the SN 106A to indicate that the UE 102 has activated the SCG, in response to the SN Modification Required message.

In some implementations, the SN 106A includes an indication (e.g., a field or an information element (IE)) to activate the SCG in the 309B SN Modification Required message to cause the MN 104A to transmit 336B the RRC reconfiguration message to activate the SCG. The SN 106A activates 338B the SCG after determining 327B to activate the SCG. In some implementations, the SN 106A activates 338B the SCG before or after receiving 343B the SN Modification Confirm message. The events 323B, 325B, 327B, 329B, 334B, 336B, 338B, 340B, 343B, 344B and 346B are collectively referred to in FIG. 3B as an SCG activation procedure 361B.

The deactivation and activation procedures discussed with reference to FIGS. 3A-3B, and with reference to FIGS. 3C-7 below, may be combined. For example, the UE 102, MN 104A, and SN 106A may perform the SCG deactivation procedure 350A to deactivate the SCG, and the SCG activation procedure 361B to activate the SCG. Similarly, the UE 102, MN 104A, and SN 106A may perform the SCG deactivation procedure 351B to deactivate the SCG, and the SCG activation procedure 360A to activate the SCG.

Referring next to FIG. 3C, in a scenario 300C, the base station 104A operates as an MN, and the base station 106A operates as an SN. The scenario 300C is generally similar to the scenarios 300A and 300B, except that the UE 102 communicates directly with the SN 106A. With the exception of the differences shown in FIG. 3C and the differences described below, any of the alternative implementations discussed above with respect to the scenarios 300A and 300B (e.g., for messaging and processing) may apply to the scenario 300C.

In response to determining 307C to deactivate the SCG, the SN 106A generates an RRC message to deactivate the SCG and transmits 315C the RRC reconfiguration message to the UE 102 on an SRB (e.g., SRB3) that the MN 104A or SN 106A configures to exchange RRC messages between the UE 102 and the SN 106A. In response, the UE 102 deactivates 316C the SCG. The UE 102 can transmit 319C an RRC reconfiguration complete message to the SN 106A on the SRB in response to the RRC reconfiguration message. Alternatively, the SN 106A transmits 315C the RRC reconfiguration message to the UE 102 via the MN 104A. The UE 102 can transmit 319C the RRC reconfiguration complete message to the SN 106A via the MN 104A.

In some implementations, if the UE 102 is required to transmit the RRC reconfiguration message, the UE 102 can transmit 319C the RRC reconfiguration complete message before or after deactivating the SCG. In other implementations, the SN 106A deactivates 322C the SCG after determining 307C to deactivate the SCG or transmitting 315C the RRC reconfiguration message. In yet other implementations, if the UE 102 transmits the RRC reconfiguration complete message, the SN 106A deactivates 322C the SCG after receiving 319C the RRC reconfiguration complete message. In yet other implementations, the SN 106A deactivates 322C the SCG after receiving an acknowledgement message from the UE 102, acknowledging that the UE 102 receives PDU(s) including the RRC reconfiguration message. For example, the acknowledgement message can be an RLC acknowledgement PDU or a hybrid Automatic Repeat Request (HARD) acknowledgement.

In some implementations, the SN 106A can send 309C to the MN 104A an SN Modification Required message to obtain a permission from the MN 104A to deactivate the SCG after determining 307C to deactivate the SCG. The MN 104A can send 311C to the SN 106A an SN Modification Confirm message indicating the MN 104A permits the SN 106A to deactivate the SCG. After obtaining the permission, the SN 106A transmits 315C the RRC reconfiguration message to the UE 102.

In other implementations, the SN 106A does not need permission from the MN 104A. The SN 106A can send to the MN 104A an SN message (e.g., SN Modification Required message, SN Deactivation Notification message, or an X2 or Xn interface message) indicating that the SCG is deactivated after determining 307C to deactivate the SCG. In one implementation, the SN 106A can send the SN message before or after transmitting 315C the RRC reconfiguration message. In another implementation, the SN 106A can send 309C the SN message before or after receiving 319C the RRC reconfiguration complete message.

The events 305C, 307C, 309C, 311C, 315C, 316C, 319C, and 322C are collectively referred to in FIG. 3C as an SCG deactivation procedure 352C.

Referring next to FIG. 3D, in a scenario 300D, the base station 104A operates as an MN, and the base station 106A operates as an SN. The scenario 300D is generally similar to the scenarios 300A-C, but with the UE 102 determining to deactivate the SCG. With the exception of the differences shown in FIG. 3D and the differences described below, any of the alternative implementations discussed above with respect to the scenarios 300A-C (e.g., for messaging and processing) may apply to the scenario 300D.

The UE 102 in DC determines 382D to deactivate the SCG. For example, the UE 102 can determine 382D to deactivate the SCG based on a battery level at the UE, or based on whether the UE 102 has data to transmit via the SCG or expects to receive data via the SCG. In response to the determination, the UE 102 transmits 384D an SCG deactivation command to the SN 106A on an SRB (e.g., SRB3) that the MN 104A or SN 106A configures to exchange RRC messages between the UE 102 and the SN 106A. Alternatively, the UE 102 transmits the SCG deactivation command to the SN 106A via the MN 104A. The SN 106A deactivates 322D the SCG in response to the SCG deactivation command. The SN 106A may send 375D to the MN 104A an SN message (e.g., SN Modification Required message, SN Deactivation Notification message or an X2 or Xn interface message) indicating the SCG is deactivated. The events 382D, 384D, 316D, 322D, and 375D are collectively referred to in FIG. 3D as an SCG deactivation procedure 353D.

At a later time, the UE 102 can activate 386D the SCG. For example, the UE 102 can determine that the UE 102 has data to transmit to the SN 106A. In response to the activation, the UE 102 performs 344D a random access procedure with the SN 106A. After the UE 102 successfully completes the random access procedure with the SN 106A, the UE 102 can communicate 346D data (user-plane data and/or control-plane data) in DC with both the MN 104A and the SN 106A. Having identified the UE 102 in the random access procedure, the SN 106A can communicate 346D data (user-plane data or control-plane data) with the UE 102 in accordance with the first SN configuration. The events 386D, 344D, 334D, 336A, 388D, and 346D are collectively referred to in FIG. 3D as an SCG activation procedure 363D.

In the description above, the SCG deactivation procedures and the SCG activation procedures in the scenarios 300A-D can be independent. For example, the UE 102, MN 104A, and SN 106A may perform the SCG deactivation procedure 350A to deactivate the SCG, and the SCG activation procedure 361B to activate the SCG. Similarly, the UE 102, MN 104A, and SN 106A may perform the SCG deactivation procedure 351B to deactivate the SCG, and the SCG activation procedure 360A to activate the SCG.

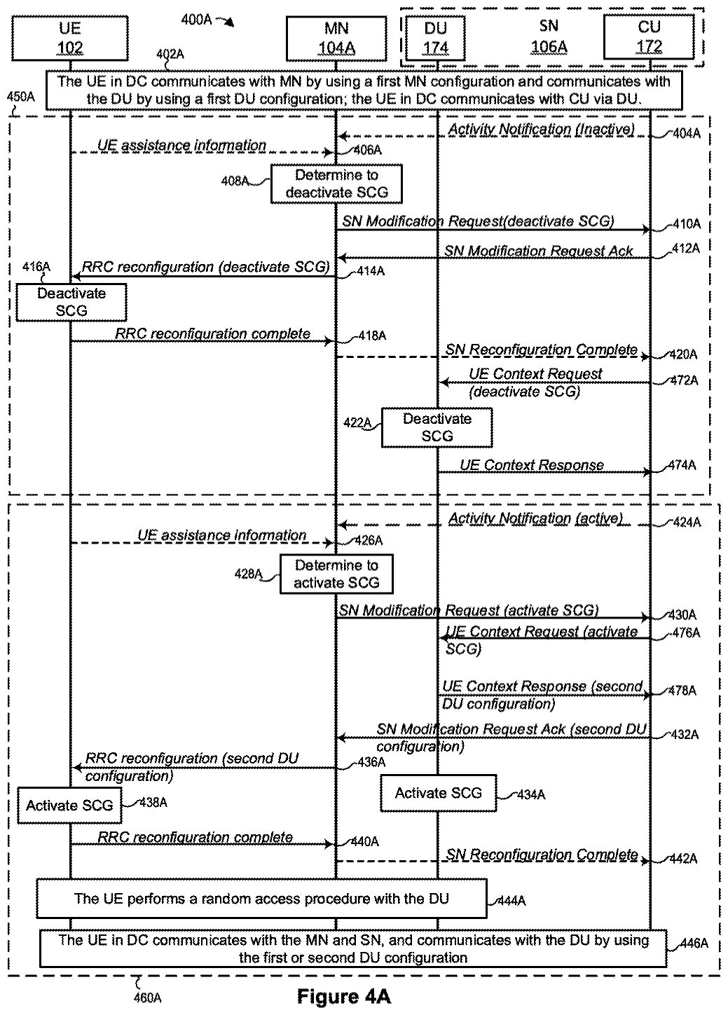

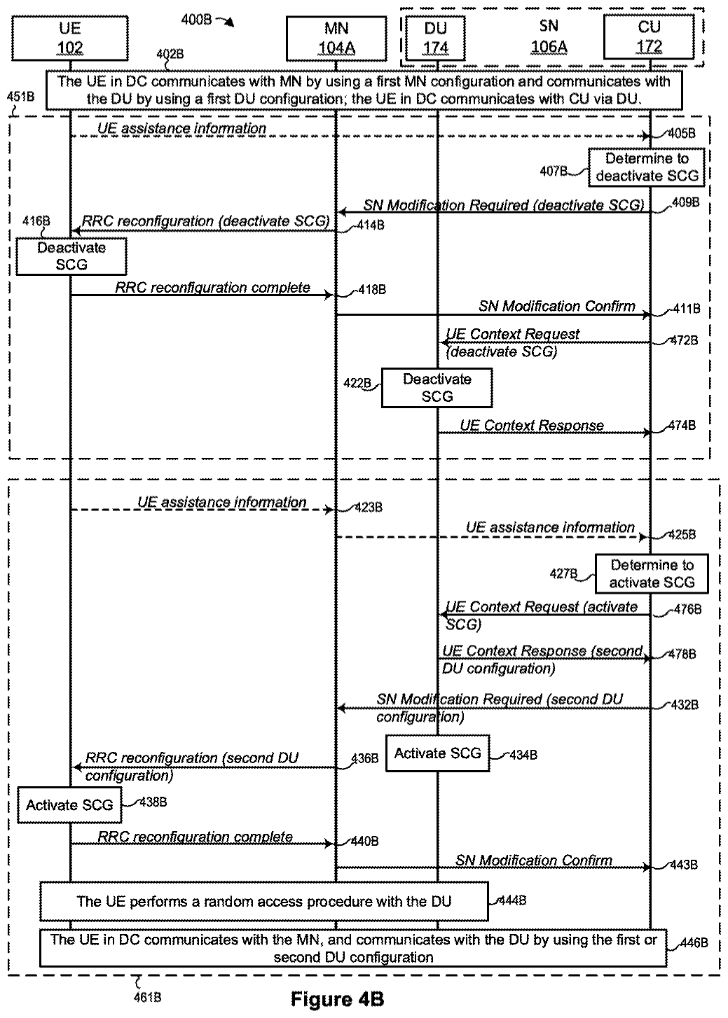

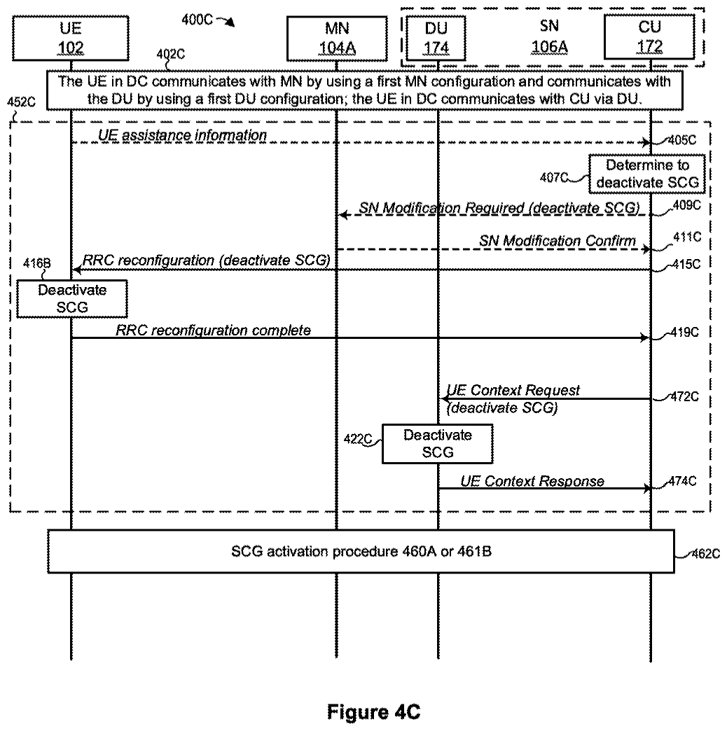

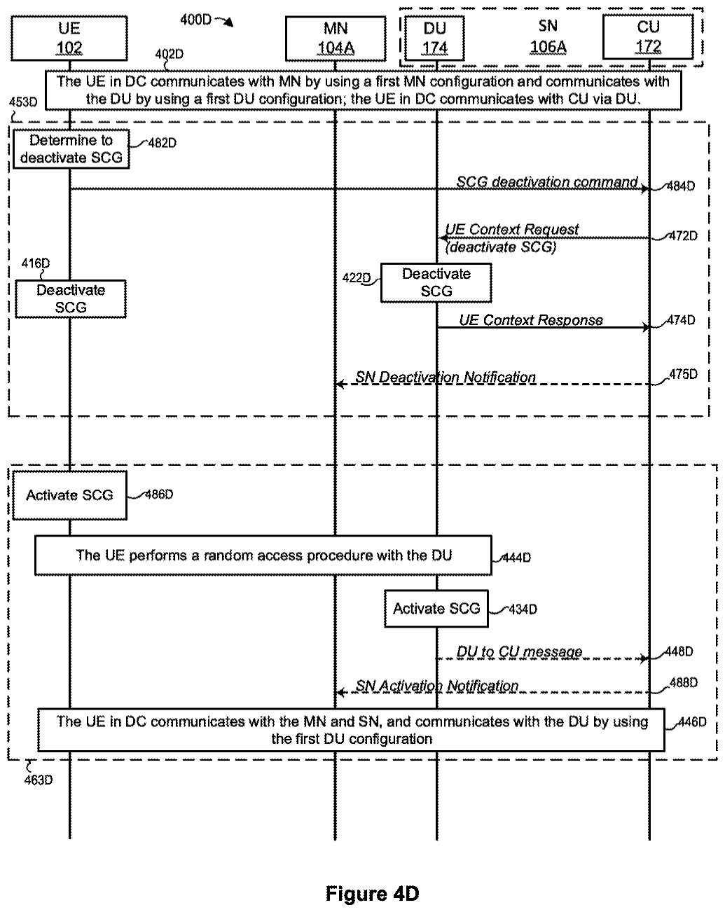

FIGS. 4A-4D are example message sequences similar to FIGS. 3A-3D, but where the SN 106A includes both a CU and a DU. Accordingly, events in the scenarios depicted in FIGS. 4A-4D and similar to those discussed with respect to FIGS. 3A-3D are labeled with similar reference numbers (e.g., with event 402A being similar to event 302A or 302B, etc.). With the exception of the differences shown in the figures and the differences described below, any of the alternative implementations discussed above with respect to the scenarios 300A-D (e.g., for messaging and processing) may apply to the scenarios 400A-D, respectively.

Turning first to FIG. 4A, in a scenario 400A, the base station 104A operates as an MN, and the base station 106A operates as an SN that includes a CU 172 and a DU 174. The scenario 400A is generally similar to the scenario 300A, with the exception that the SN 106A includes the CU 172 and the DU 174. Accordingly, at the start of the scenario 400A, the UE 102 communicates 402A in DC with the MN 104A in accordance with a first MN configuration, with the DU 174 in accordance with a first DU configuration, and with the CU 172 via the DU 174. The MN 104A then determines 408A to deactivate the SCG for communication with the UE 102, similar to event 308A.

In response to the determination 408A, the MN 104A sends 410A to the CU 172 an SN Modification Request message that that deactivates the SCG for the UE 102. In response to the SN Modification Request message, the CU 172 sends 472A to the DU 174 a UE Context Request message deactivating the SCG. In response to the UE Context Request message, the DU 174 deactivates 422A the SCG and sends 474A a UE Context Response message to the CU 172. The DU 174 can send 474A the UE Context Response message before or after deactivating the SCG.

In some implementations, the CU 172 can include an indication deactivating the SCG in the UE Context Request message that the CU 172 transmits 472A to cause the DU 174 to deactivate the SCG. In other implementations, the SN 106A can include an indication suspending lower layers in the UE Context Request message that the CU 172 transmits 472A to cause the DU 174 to deactivate the SCG. In this case, the CU 172 may or may not include the indication deactivating the SCG in the UE Context Request message that the CU 172 transmits 472A.

In some implementations, the DU 174 suspends and/or reset (or re-establish) lower layers (e.g., PHY 202A/202B, MAC 204A/204B, and/or RLC 206A/206B) for communication with the UE 102 after deactivating the SCG, as described for the SN 106A for FIG. 3A.

The CU 172 can then send 412A to the MN 104A an SN Modification Request Acknowledge message in response to the 410A SN Modification Request message, similar to the event 312A. The events 404A, 406A, 408A, 410A, 412A, 414A, 416A, 418A, 420A, and 422A are similar to the events 304A, 306A, 308A, 310A, 312A, 314A, 316A, 318A, 320A, and 322A respectively. The events 404A, 406A, 408A, 410A, 474A, 412A, 414A, 416A, 418A, 420A, 472A, 422A, and 474A are collectively referred to in FIG. 4A as an SCG deactivation procedure 450A.

After deactivating the SCG, the MN 104A can determine 428A to activate the SCG for communication with the UE 102, similar to the event 328A. In response to the determination 428A, the MN 104A sends 430A to the CU 172 an SN Modification Request message that that activates the SCG for the UE 102. In response to the SN Modification Request message, the CU 172 sends 476A to the DU 174 a UE Context Request message activating the SCG. In response to the UE Context Request message, the DU 174 activates 434A the SCG and sends 478A a UE Context Response message to the CU 172. The DU 174 can send 478A the UE Context Response message before or after activating the SCG. In some implementations, the DU 174 can include, in the UE Context Response message, a second DU configuration similar to the second SN configuration.

In some implementations, the CU 172 can include an indication activating the SCG in the UE Context Request message that the CU 172 transmits 476A to cause the DU 174 to activate the SCG. In other implementations, the CU 172 can include an indication resuming lower layers in the UE Context Request message that the CU 172 transmits 476A to activate the SCG. In this case, the CU 172 may or may not include the indication activating the SCG in the UE Context Request message that the CU 172 transmits 476A. In yet other implementations, the CU 172 does not include the indication to deactivate the SCG in the UE Context Request message that the CU 172 transmits 476A to cause the DU 174 to activate the SCG.

In some implementations, the DU 174 resumes or resets (or re-establishes) lower layers (e.g., PHY 202A/202B, MAC 204A/204B, and/or RLC 206A/206B) for communication with the UE 102 after activating the SCG, as described for SN 106A for FIG. 3A.

The CU 172 can send 432A to the MN 104A an SN Modification Request Acknowledge message in response to the SN Modification Request message the CU receives 430A, similar to the event 332A. After receiving the 432A SN Modification Request Acknowledge message, the MN 104A transmits 436A an RRC reconfiguration message to the UE 102 to activate the SCG. If the CU 172 receives the second DU configuration from the DU 174, the CU 172 can include the second DU configuration in the SN Modification Request message the CU 172 transmits 430A and the MN 104A includes the second DU configuration in the RRC reconfiguration message the MN 104A transmits 436A. More specifically, the CU 172 can generate a second SN configuration including the second DU configuration. Then the CU 172 includes the second SN configuration in the SN Modification Request Acknowledge message the CU 172 transmits 432A, and the MN 104A can include the second SN configuration in the RRC reconfiguration message the MN 104A transmits 436A similar to the events 332A and 336A respectively. In some implementations, the MN 104A can include an indication to activate the SCG in 436A the RRC reconfiguration message. In other implementations, the MN 104A does not include an indication to activate the SCG in the RRC reconfiguration message the MN transmits 436A.

At some point after receiving 436A the RRC reconfiguration message or in response to the 436A the RRC reconfiguration message, the UE 102 can perform 444A a random access procedure on cell 126A with the DU 174 to activate the SCG with the DU 174. In some implementations, the UE 102 performs the random access procedure using one or more random access configurations in the second DU configuration. In other implementations, the UE 102 preforms the random access procedure using one or more random access configurations that the UE 102 received from the CU 172 before activating or deactivating the SCG. Having identified the UE 102 in the random access procedure, the DU 174 can send a message (e.g., a Downlink Data Delivery Status, Access Success or UL RRC Message Transfer message) to the CU 172 to indicate the UE 102 has connected to the DU 174. The DU 174 can activate 434A the SCG after or in response to identifying the UE 102 in the random access procedure.

After the UE 102 successfully completes the random access procedure on the cell 126A with the DU 174, the UE 102 can communicate 446A data (user-plane data and/or control-plane data) in DC with both the MN 104A and the SN 106A through the cell 124A and the cell 126A respectively. More specifically, the UE 102 in DC communicates 446A data (user-plane data and/or control-plane data) with the DU 174 using the first or second DU configuration.

In some implementations, the DU 174 can include new configuration parameters for the SCG in the second DU configuration. The UE 102 uses the new configuration parameters to communicate 446A data (user-plane data and/or control-plane data) with the DU 174 after activating the SCG. In another example, the DU 174 can indicate, in the second DU configuration, to release configuration parameter(s) included in the first DU configuration. Thus, the UE 102 releases the configuration parameter(s) and does not use the released configuration parameter(s) to communicate 446A data (user-plane data and/or control-plane data) with the DU 174 after activating the SCG. If the RRC reconfiguration message that the UE 102 receives 446A does not include a DU configuration, the UE 102 communicates 446A data (user-plane data and/or control-plane data) with the DU 174 using the first DU configuration.

In some implementations, the UE Context Request message and the UE Context Response message are UE Context Modification Request message and the UE Context Modification Response message, respectively. In some implementations, the UE Context Request message and the UE Context Response message are UE Context Setup Request message and the UE Context Setup Response message, respectively.

The events 424A, 426A, 428A, 430A, 432A, 434A, 436A, 438A, 440A, 442A, 444A, and 446A are similar to the events 324A, 326A, 328A, 330A, 332A, 334A, 336A, 338A, 340A, 342A, 344A, and 346A, respectively. The events 424A, 426A, 428A, 430A, 476A, 478A, 432A, 434A, 436A, 438A, 440A, 442A, 444A, and 446A are collectively referred to in FIG. 4A as an SCG activation procedure 460A.

Referring next to FIG. 4B, in a scenario 400B, the base station 104A operates as an MN, and the base station 106A operates as an SN that includes a CU 172 and a DU 174. The scenario 400B is generally similar to the scenarios 400A, but with the CU 172 determining to deactivate the SCG and activate the SCG. The scenario 400B is also generally similar to the scenario 300B, but with the SN 106A including the CU 172 and the DU 174.

After event 402B, the CU 172 determines 407B to deactivate the SCG for communication with the UE 102, similar to the determination 307B. In response to the determination 407B, the CU 172 sends 472B to the DU 174 a UE Context Request message deactivating the SCG. In response to the UE Context Request message, the DU 174 deactivates 422B the SCG and sends 474B a UE Context Response message to the CU 172. The DU 174 can send 474A the UE Context Response message before or after deactivating the SCG. The events 405B, 407B, 409B, 414B, 416B, 418B, 411B, 472B, 422B, and 474B are collectively referred to in FIG. 4B as an SCG deactivation procedure 451B.

At a later time, the CU 172 can determine 427B to activate the SCG for communication with the UE 102, and can transmit 476B a UE Context Request message to the DU 174 to activate the SCG. In response, the DU 174 activates 434B the SCG and sends 478B a UE Context Response message to the CU 172. The DU 174 can send 478B the Context Response message before or after activating the SCG. In some implementations, the DU 174 can include, in the UE Context Response message, a second DU configuration similar to the second SN configuration. The events 423b, 425B, 427B, 476B, 478B, 432B, 434B, 436B, 438B, 440B, 443B, 444B, and 446B are collectively referred to in FIG. 4B as an SCG activation procedure 461B.

Referring next to FIG. 4C, in a scenario 400C, the base station 104A operates as an MN, and the base station 106A operates as an SN that includes a CU 172 and a DU 174. The scenario 400C is generally similar to the scenario 300C, with the exception that the SN 106A includes the CU 172 and the DU 174. Accordingly, after determining 407C to deactivate the SCG, the CU 172 can send 472C a UE Context Request message that causes the DU 174 to deactivate 422C the SCG. The DU 174 can send 474C a UE Context Response message to the CU 172 in response to the UE Context Request. The events 405C, 407C, 409C, 411C, 415C, 416B, 419C, 472C, 422C, and 474C are collectively referred to in FIG. 4C as an SCG deactivation procedure 452C. After the SCG deactivation procedure 452C, the scenario 400A may include an SCG activation procedure, such as the SCG activation procedure 460A or the SCG activation procedure 461B.

Referring next to FIG. 4D, in a scenario 400D, the base station 104A operates as an MN, and the base station 106A operates as an SN that includes a CU 172 and a DU 174. The scenario 400D is generally similar to the scenario 300D, with the exception that the SN 106A includes the CU 172 and the DU 174. Accordingly, after determining 482D to deactivate the SCG, the UE 102 sends 484D an SCG deactivation command to the CU 172. The CU 172 can send 472D a UE Context Request message to the DU 174 that causes the DU 174 to deactivate 422D the SCG. The DU 174 can send 474D a UE Context Response message to the CU 172 in response to the UE Context Request. The events 482D, 484D, 472D, 422D. 474D, 416D, and 475D are collectively referred to in FIG. 4D as an SCG deactivation procedure 453D.

At a later time, the UE 102 can activate 486D the SCG. In response to the activation, the UE 102 performs 444D a random access procedure with the DU 174. In some implementations, the DU 174 activates 434D the SCG upon detecting the UE 102 in the random access procedure (e.g., by receiving a dedicated preamble or a UE identity of the UE 102 during the random access procedure). After activating 434D the SCG, the DU 174 can send 448D a DU to CU message (e.g., a Downlink Data Delivery Status, Access Success or UL RRC Message Transfer message) to the CU 172 to indicate that the UE 102 has connected to the DU 174. In other implementations, after the DU 174 detects the UE 102 in the random access procedure but before the DU 174 activates 434D the SCG, the DU 174 sends 448D a DU to CU message to the CU 172. The CU 172 then performs a UE Context procedure (e.g., by transmitting a UE Context Request to the DU 174 including an indication to activate the SCG and receiving a UE Context Response from the DU 174, similar to events 476A-C, 478A-C) with the DU 174 to cause the DU 174 to activate 434D the SCG. Events 486D, 444D. 434D, 448D, 488D, and 446D are collectively referred to in FIG. 4D as an SCG activation procedure 463D.

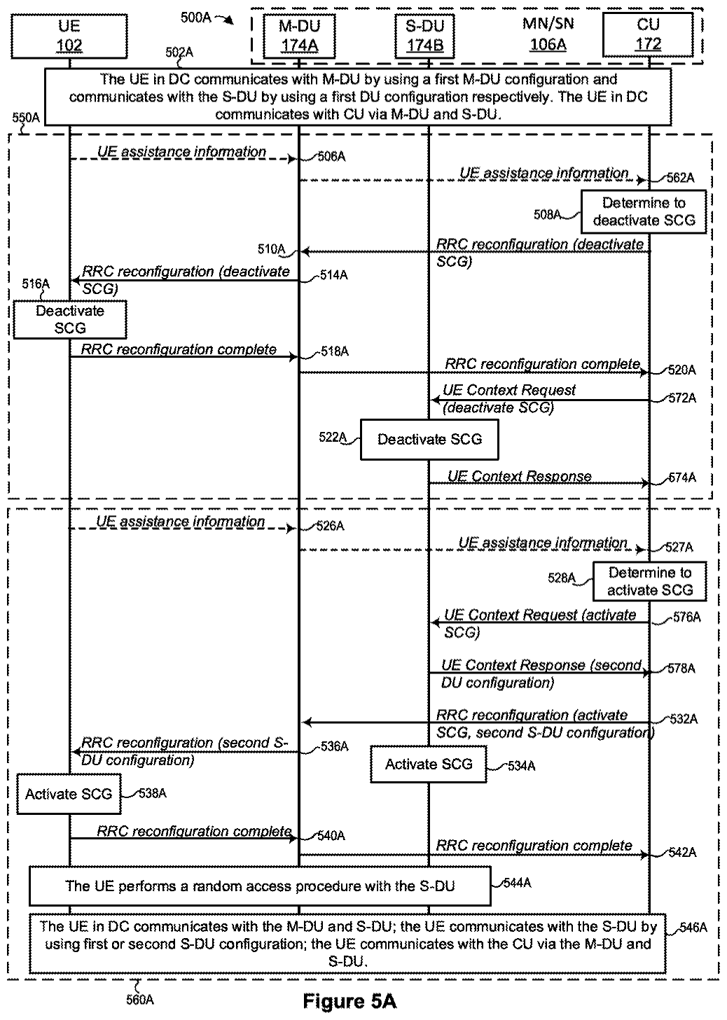

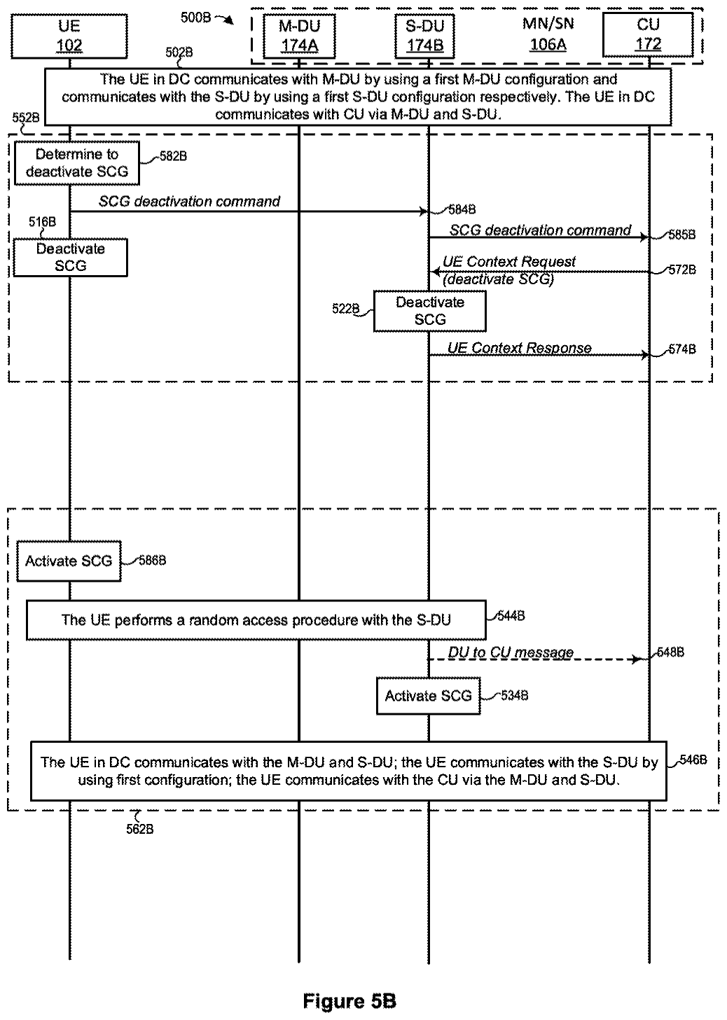

FIGS. 5A-5B are example message sequences similar to FIGS. 4A-4D, but where portions of a single base station serve as the MN and the SN. Accordingly, events in the scenarios depicted in FIGS. 5A-5B similar to those discussed with respect to FIGS. 4A-4D are labeled with similar reference numbers. With the exception of the differences shown in the figures and the differences described below, any of the alternative implementations discussed above with respect to the scenarios 400A-C and 400D (e.g., for messaging and processing) may apply to the scenarios 500A and 500B, respectively. As one example difference, the MN and the SN in FIGS. 5A-5B do not need to exchange SN Modification Request and SN Modification Request Acknowledge messages, as in FIGS. 4A-4D.

Turning to FIG. 5A, in a scenario 500A, the base station 106A operates as both an MN and an SN, with the MN including a CU (e.g., the CU 172) and a first DU (e.g., a DU 174A of the one or more DUs 174, referred to herein as an M-DU 174A) of the base station 106A, and the SN including the same CU and a second, different DU (e.g., a DU 174B of the one or more DUs 174, referred to herein as an S-DU 174B) of the base station 106A. The scenario 500A is generally similar to the scenarios 400A-C, with the exception that the single base station 106A includes both the MN and the SN. Accordingly, at the start of the scenario 500A, the UE 102 communicates 502A in DC with the M-DU 174A in accordance with a first M-DU configuration, with the S-DU 174B in accordance with a first S-DU configuration, and with the CU 172 via the M-DU 174A and S-DU 174B. The MN 104A then determines 508A to deactivate the SCG for communication with the UE 102, similar to event 408A, 407B or 407C.

In response to the determination 508A, the CU 172 sends 510A to the M-DU 174A an RRC reconfiguration message that that deactivates the SCG for the UE 102, unlike the event 410A. The M-DU 174A in turn transmits 514A the RRC reconfiguration message to the UE 102, similar to the event 414A. In response to the RRC reconfiguration message the UE 102 receives 514A, the UE 102 deactivates 516A the SCG and transmits 518A an RRC reconfiguration complete message to the M-DU 174A, similar to the event 416A and 418A respectively. Then the M-DU 174A transmits 520A the RRC reconfiguration complete message to the CU 172, unlike the event 420A. After deactivating the SCG, the MN 104A can determine 528A to activate the SCG for communication with the UE 102, similar to event 428A. In response to the determination 528A, the CU 172 sends 532A to the M-DU 174A an RRC reconfiguration message that that activates the SCG for the UE 102, unlike the event 432A. The M-DU 174A in turn transmits 536A the RRC reconfiguration message to the UE 102, similar to the event 436A. In response to the RRC reconfiguration message the UE 102 receives 536A, the UE 102 activates 538A the SCG and transmits 540A an RRC reconfiguration complete message to the M-DU 174A, similar to the event 438A and 440A respectively. Then the M-DU 174A transmits 542A the RRC reconfiguration complete message to the CU 172, unlike the event 442A.

Alternatively, in response to the determination 508A, the CU 172 sends 510A the RRC reconfiguration message to the S-DU 174B, and the S-DU 174B in turn transmits 514A the RRC reconfiguration message to the UE 102. In response to the RRC reconfiguration message the UE 102 receives 514A, the UE 102 deactivates 516A the SCG and transmits 518A the RRC reconfiguration complete message to the S-DU 174A, similar to the event 415C and 419C respectively. Then the S-DU 174A transmits 520A the RRC reconfiguration complete message to the CU 172, similar to the event 419C.

At some point after receiving 536A the RRC reconfiguration message or in response to the 536A the RRC reconfiguration message, the UE 102 can perform 544A a random access procedure on cell 126A with the S-DU 174B to activate the SCG with the S-DU 174B, similar to the event 444A. After the UE 102 successfully completes the random access procedure on the cell 126A with the S-DU 174B, the UE 102 can communicate 546A data (user-plane data and/or control-plane data) in DC with both the M-DU 174A and the S-DU 174B through the cell 125A and cell 126A respectively. More specifically, the UE 102 communicates 546A data (user-plane data and/or control-plane data) with the DU 174 using the first or second DU configuration.

The events 506A, 562A, 508A, 513A, 514A, 516A, 518A, 521A, 572A, 522A, and 574A are collectively referred to in FIG. 5A as an SCG deactivation procedure 550A. The events 526A, 527A, 528A, 576A, 578A, 532A, 534A, 536A, 538A, 540A, 542A, 544A, and 546A are collectively referred to in FIG. 5A as an SCG activation procedure 560A.

Referring next to FIG. 5B, in a scenario 500B, the base station 106A operates as both an MN and an SN, with the MN including the CU 172 and a first DU 174A and the SN including the CU 172 and a second DU 174B. The scenario 500B is generally similar to the scenario 500A, but with the UE 102 determining to deactivate the SCG. The scenario 500B is also generally similar to the scenario 400D, with the exception that the base station 106A includes both the MN and the SN.

Accordingly, after the UE 102 determines 582B to deactivate the SCG, the UE 102 transmits 584B an SCG deactivation command to the S-DU 174B, which forwards 585B the SCG activation command to the CU 172. The CU 172 can send 572B a UE Context Request message to the S-DU 174B that causes the S-DU 174B to deactivate 522B the SCG. The S-DU 174B can send 574B a UE Context Response message to the CU 172 in response to the UE Context Request. The events 582B, 584B, 585B, 572B, 516B, 522B, and 574B are collectively referred to in FIG. 5B as an SCG deactivation procedure 552B.

At a later time, the UE 102 can activate 586B the SCG. In response to the activation, the UE 102 performs 544B a random access procedure with the S-DU 174B. In some implementations, the S-DU 174B activates 534B the SCG upon detecting the UE 102 in the random access procedure (e.g., by receiving a dedicated preamble or a UE identity of the UE 102 during the random access procedure). After activating 534B the SCG, the S-DU 174B can send 548B a DU to CU message (e.g., a Downlink Data Delivery Status, Access Success or UL RRC Message Transfer message) to the CU 172 to indicate that the UE 102 has connected to the S-DU 174B. In other implementations, after the S-DU 174B detects the UE 102 in the random access procedure but before the S-DU 174B activates 534B the SCG, the S-DU 174B sends 548D a DU to CU message to the CU 172. The CU 172 then performs a UE Context procedure (e.g., by transmitting a UE Context Request to the DU 174 including an indication to activate the SCG and receiving a UE Context Response from the DU 174, similar to events 476A-C, 478A-C) with the DU 174 to cause the S-DU 174B to activate 534B the SCG. Events 586B, 544B. 534B, 548B, and 546B are collectively referred to in FIG. 5B as an SCG activation procedure 562B.

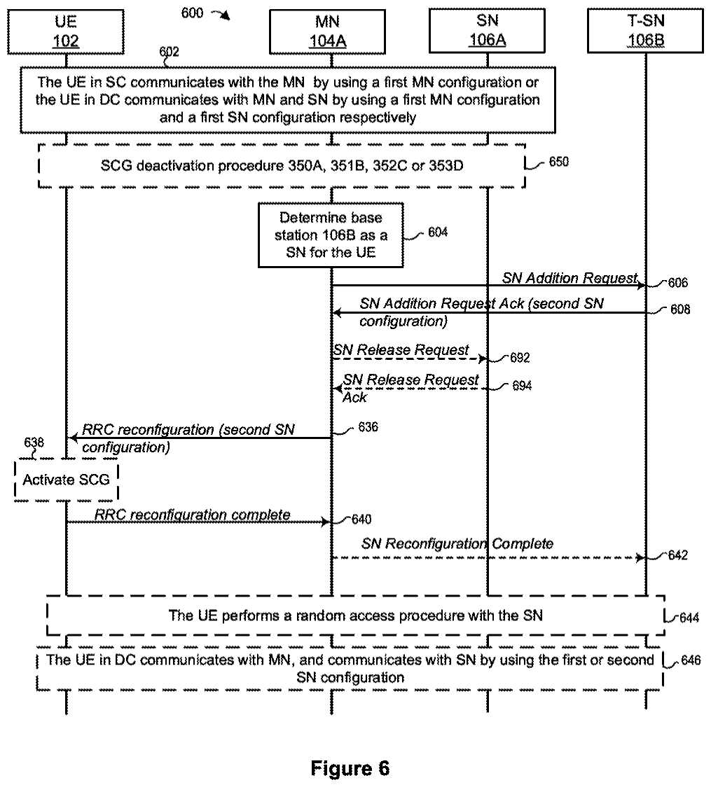

Referring next to FIG. 6, a scenario 600, the base station 104A operates as an MN, the base station 106A operates as an SN and the base station 106B operates as a target SN (T-SN). The scenario 600 is generally similar to the scenarios 300A-D, but with the MN 104A, determining to change the SN for the UE 102. As mentioned above, events in the scenario 600 similar to those discussed above with respect to the scenarios 300A-D are labeled with similar reference numbers (e.g., with event 302A of FIG. 3A, event 302B of FIG. 3B, event 302C of FIG. 3C, event 302D of FIG. 3D corresponding to event 602 of FIG. 6). With the exception of the differences shown in FIG. 6 and the differences described below, any of the alternative implementations discussed above with respect to the scenarios 300A-D (e.g., for messaging and processing) may apply to the scenario 600. Accordingly, at the start of the scenario 600, the UE 102 communicates 602 in DC with the MN 104A in accordance with a first MN configuration, with the SN 106A in accordance with a first SN configuration. The RAN 105 then performs 650 an SCG deactivation procedure with the UE 102 to deactivate an SCG on which the UE 102 and the SN 106A communicate with each other, similar to the SCG deactivation procedure 350A, 351B, 352C or 353D.

After the RAN 105 deactivates the SCG, the MN 104A determines 604 to change the SN from the SN 106A to the T-SN 106B for the UE 102. In some implementations, the MN 104A can make the determination 604 based on one or more measurement results received from the UE, e.g., if measurement result(s) for cell 126B are above a first threshold and/or measurement result(s) for cell 126A are below a second threshold. In other implementations, the MN 104A can make the determination 604 in response to receiving an SN Change Required message from the SN 106A. In response to the determination 604, the MN 104A sends 606 an SN Addition Request message to the T-SN 106B. In response, the T-SN 106B sends 608 an SN Addition Request Acknowledge message including a second SN configuration to the MN 104A. After receiving the SN Addition Request Acknowledge message, the MN 104A transmits 636 an RRC reconfiguration message including the second SN message to the UE 102. In response to the RRC reconfiguration message, the UE 102 transmits 640 an RRC reconfiguration complete message to the MN 104A and can activate 638 the SCG. After receiving the RRC reconfiguration complete message, the MN 104A can send 642 an SN Reconfiguration Complete message to the SN 106A to indicate that the UE 102 received or applied the second SN configuration. After activating 638 the SCG, the UE 102 performs 644 a random access procedure with the T-SN 106B on the cell 126B, similar to the event 344A. After the UE 102 successfully completes the random access procedure on the cell 126B with the T-SN 106B, the UE 102 can communicate 646 data (user-plane data and/or control-plane data) in DC with both the MN 104A and the T-SN 106B through the cell 124A and cell 126B respectively, similar to the event 346A.

In some scenarios and implementations, the MN 104A can indicate to deactivate the SCG in the SN Addition Request message and in the RRC reconfiguration message. Thus, the T-SN 106B deactivates the SCG in response to the indication deactivating the SCG. In this case, the MN 104A indicates to deactivate the SCG in the RRC reconfiguration message. Thus, the UE 102 does not activate the SCG in response to the indication deactivating the SCG and does not perform a random access procedure in response to the RRC reconfiguration message. That is, the UE 102 retains the deactivated SCG even though the UE 102 receives the second SN configuration for PSCell change (i.e., configuring a new PSCell 126B). After that, the RAN 105 (i.e., the MN 104A or the SN 106B) can perform an SCG activation procedure with the UE 102 to activate the SCG, similar to the SCG activation procedure 360A, 361B or 363D.

In some implementations, the MN 104A transmits 692 a message to the SN 106A (e.g., an SN Release Request) indicating that the SN 106A can release the deactivated SCG. In response, the SN 106A may release configurations relating to the deactivated SCG and transmit 694 a message (e.g., an SN Release Request Acknowledgement) to the MN 104A to indicate that the SN 106A has released the SCG.

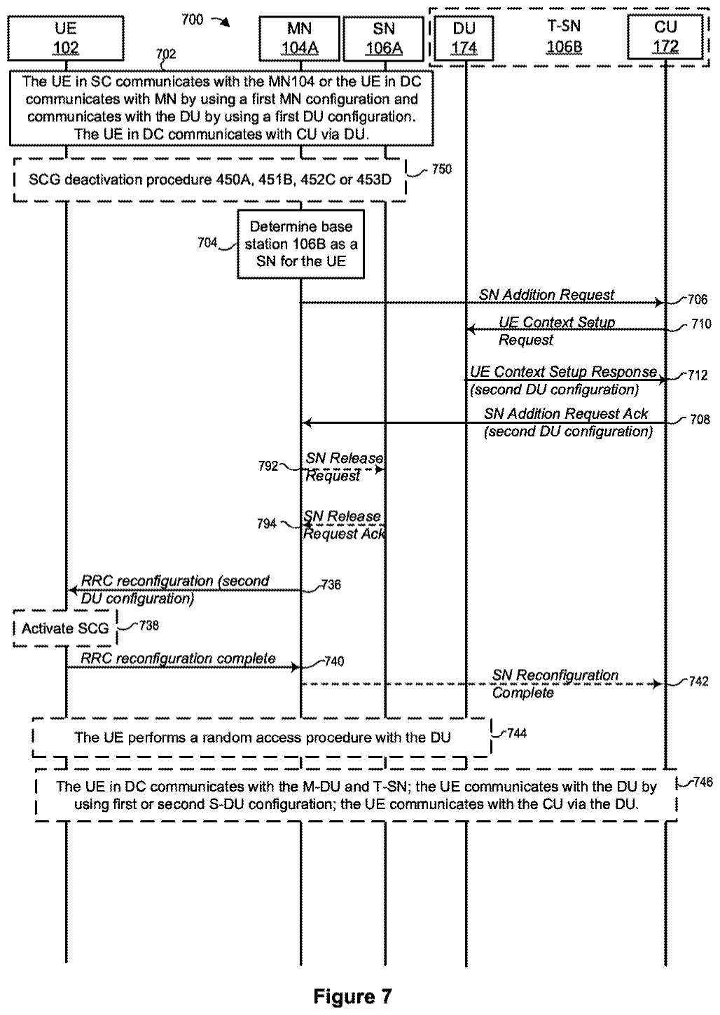

Referring next to FIG. 7, in a scenario 700, the base station 104A operates as an MN, the base station 106A operates as an SN and the base station 106B operates as a target SN (T-SN). The scenario 700 is generally similar to the scenario 600, but where the T-SN 106B includes a DU 174 and a CU 172. At the start of the scenario 700, the UE 102 communicates 702 in DC with the MN 104A using a first MN configuration and communicates with the SN 106A using a first SN configuration. More particularly, the SN 106A may include a DU and a CU, and the UE 102 can communicate with the DU of the SN 106A using a first DU configuration, and can communicate with the CU via the DU. The RAN 105 then performs 750 an SCG deactivation procedure with the UE 102 to deactivate an SCG on which the UE 102 and the SN 106A communicate with each other, similar to the SCG deactivation procedure 450A, 451B, 452C, or 453CD.

After the RAN 105 deactivates the SCG, the MN 104A determines 704 to change the SN from the SN 106A to the T-SN 106B for the UE 102, similar to the determination 604. To change the SN to the T-SN 106B, the MN 104A transmits 607 an SN Addition Request to the CU 172. In response to receiving 706 an SN Addition Request, the CU 172 transmits 710 a UE Context Setup Request to the DU 174. In response, the DU 174 can generate a second DU configuration the UE 102 is to use to communicate with the DU 174, and transmit 712 the second DU configuration to the CU 172 in a UE Context Setup Response message. The CU 172 can transmit 708 an SN Addition Request Acknowledge message including the second DU configuration to the MN 104A.

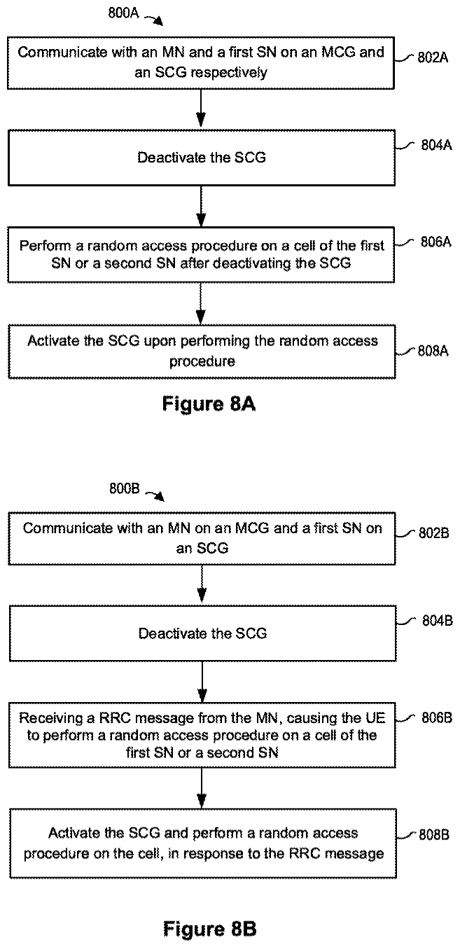

FIGS. 8-24 are flow diagrams depicting methods that RAN nodes or a UE (such as the UE 102) can perform for deactivating and activating an SCG between the UE 102 and the RAN 105.

FIG. 8A is a flow diagram depicting a method 800A for activating an SCG, which may be implemented by a UE (e.g., the UE 102) of this disclosure. Initially, at block 802A, the UE communicates in DC with an MN (e.g., the MN 104A or the CU 172 and M-DU 174A of the base station 106A) and a first SN (e.g., the SN 106A or the CU 172 and the S-DU 174B of the base station 106A) in accordance with an MN configuration and an SN configuration, respectively (e.g., event 302A, 302B, 302C, 302D, 402A, 402B, 402C, 402D, 502A, 502B, 602, 702). While communicating in DC with the MN (e.g., the MN 104A) and the first SN through an MCG and an SCG respectively, the UE deactivates, at block 804A, the SCG (e.g., event 316A, 316B, 316C, 316D, 416A, 416B, 416C, 416D, 516A, 516B).

At block 806A, the UE performs a random access procedure on a cell of the first SN or a second SN after deactivating the SCG (e.g., event 344A, 344B, 344D, 444A, 444B, 444D, 544A, 544B, 644, 744). At block 808A, the UE activates the SCG in response to (or after) performing the random access procedure (e.g., event 338A, 338B, 338D, 438A, 438B, 438D, 538A, 538B, 638, 738).

FIG. 8B is a flow diagram depicting a method 800B for activating an SCG, which may be implemented by a UE (e.g., the UE 102) of this disclosure. Initially, at block 802B, the UE communicates in DC with an MN (e.g., the MN 104A or the CU 172 and M-DU 174A of the base station 106A) and a first SN (e.g., the SN 106A or the CU 172 and the S-DU 174B of the base station 106A) in accordance with an MN configuration and an SN configuration, respectively (e.g., event 302A, 302B, 302C, 302D, 402A, 402B, 402C, 402D, 502A, 502B, 602, 702). While communicating in DC with the MN (e.g., the MN 104A) and the first SN through an MCG and an SCG respectively, the UE deactivates, at block 804B, the SCG (e.g., event 316A, 316B, 316C, 316D, 416A, 416B, 416C, 416D, 516A, 516B).

At block 806B, the UE receives an RRC message from the MN, causing the UE to perform a random access procedure on a cell of the first SN or a second SN (e.g., event 336A, 336B, 336D, 436A, 436B, 436D, 536A, 536B, 636, 736). At block 808B, the UE activates the SCG and perform a random access procedure on the cell in response to the RRC message (e.g., 338A, 338B, 338D, 438A, 438B, 438D, 538A, 538B, 638, 738, 344A, 344B, 344D, 444A, 444B, 444D, 544A, 544B, 644, 744).

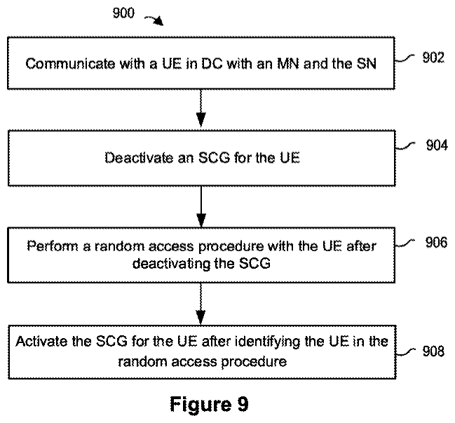

FIG. 9 is a flow diagram depicting a method 900 for activating an SCG, which may be implemented by an SN (e.g., the SN 106A or the CU 172 and the S-DU 174B of the base station 106A) of this disclosure. Initially, at block 902, the SN communicates with a UE (e.g., the UE 102) in DC with an MN (e.g., the MN 104A or the CU 172 and M-DU 174A of the base station 106A) and the SN (e.g., event 302A, 302B, 302C, 302D, 402A, 402B, 402C, 402D, 502A, 502B, 602, 702). While communicating with the UE in DC via an SCG, the SN deactivates, at block 904, the SCG (e.g., event 322A, 322B, 322C, 322D, 422A, 422B, 422C, 422D, 522A, 522B).

At block 906, the SN performs a random access procedure on a cell with the UE after deactivating the SCG (e.g., event 344A, 344B, 344D, 444A, 444B, 444D, 544A, 544B, 644, 744). At block 908, the SN activates the SCG after identifying the UE in the random access procedure (e.g., event 334A, 334B, 334D, 434A, 434B, 434D, 534A, 534B, 634, 734).

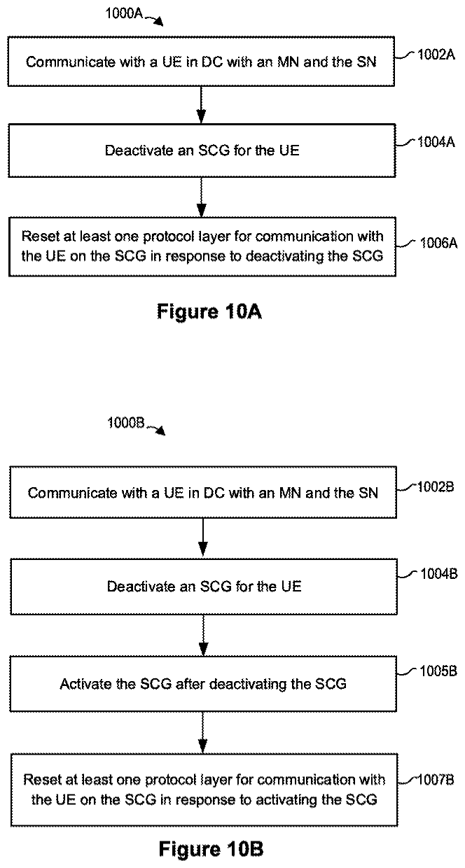

FIG. 10A is a flow diagram depicting a method 1000A for deactivating an SCG, which may be implemented by an SN (e.g., the SN 106A or the CU 172 and the S-DU 174B of the base station 106A) of this disclosure. Initially, at block 1002A, the SN communicates with a UE (e.g., the UE 102) in DC with an MN (e.g., the MN 104A or the CU 172 and M-DU 174A of the base station 106A) and the SN (e.g., event 302A, 302B, 302C, 302D, 402A, 402B, 402C, 402D, 502A, 502B, 602, 702). While communicating with the UE in DC via an SCG, the SN deactivates, at block 1004A, the SCG (e.g., event 322A, 322B, 322C, 322D, 422A, 422B, 422C, 422D, 522A, 522B). At block 1006A, the SN resets at least one protocol layer for communication with the UE on (i.e., via) the SCG in response to deactivating the SCG. Thus, after activating the SCG, the SN communicates with the UE on the SCG using the reset at least one protocol layer. Resetting the at least one protocol layer may include resetting at least one parameter of the protocol layer.

FIG. 10B is a flow diagram depicting a method 1000B for activating an SCG, which may be implemented by an SN (e.g., the SN 106A or the CU 172 and the S-DU 174B of the base station 106A) of this disclosure. Initially, at block 1002B, the SN communicates with a UE (e.g., the UE 102) in DC with an MN (e.g., the MN 104A or the CU 172 and M-DU 174A of the base station 106A) and the SN (e.g., event 302A, 302B, 302C, 302D, 402A, 402B, 402C, 402D, 502A, 502B, 602, 702). While communicating with the UE in DC via an SCG, the SN deactivates, at block 1004B, the SCG (e.g., event 322A, 322B, 322C, 322D, 422A, 422B, 422C, 422D, 522A, 522B).

At block 1005B, the SN activates the SCG after deactivating the SCG (e.g., event 334A, 334B, 334D, 434A, 434B, 434D, 534A, 534B, 634, 734). At block 1007B, the SN resets (or re-establishes) at least one protocol layer for communication with the UE on (i.e., via) the SCG in response to activating the SCG. After resetting the at least one protocol layer, the SN communicates with the UE on the SCG using the at least one protocol layer.

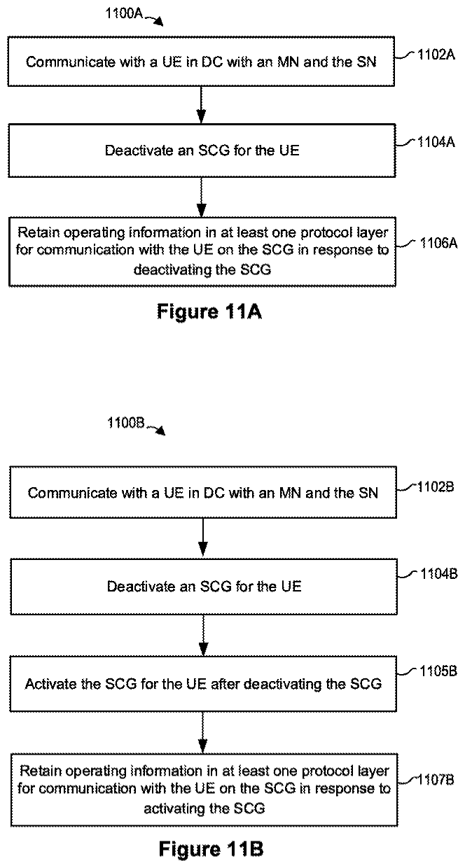

FIG. 11A is a flow diagram depicting a method 1100A for deactivating an SCG, which may be implemented by an SN (e.g., the SN 106A or the CU 172 and the S-DU 174B of the base station 106A) of this disclosure. Initially, at block 1102A, the SN communicates with a UE (e.g., the UE 102) in DC with an MN (e.g., the MN 104A or the CU 172 and M-DU 174A of the base station 106A) and the SN (e.g., event 302A, 302B, 302C, 302D, 402A, 402B, 402C, 402D, 502A, 502B, 602, 702). While communicating with the UE in DC via an SCG, the SN deactivates, at block 1104A, the SCG (e.g., event 322A, 322B, 322C, 322D, 422A, 422B, 422C, 422D, 522A, 522B). At block 1106A, the SN retains operating information in at least one protocol layer for communication with the UE on (i.e., via) the SCG in response to deactivating the SCG. After activating the SCG, the SN communicates with the UE on the SCG using the at least one protocol layer with the retained operating information. Retaining operating information in a protocol layer may include retaining at least one parameter of the protocol layer.

FIG. 11B is a flow diagram depicting a method 1100B for activating an SCG, which may be implemented by an SN (e.g., the SN 106A or the CU 172 and the S-DU 174B of the base station 106A) of this disclosure. Initially, at block 1002B, the SN communicates with a UE (e.g., the UE 102) in DC with an MN (e.g., the MN 104A or the CU 172 and M-DU 174A of the base station 106A) and the SN (e.g., event 302A, 302B, 302C, 302D, 402A, 402B, 402C, 402D, 502A, 502B, 602, 702). While communicating with the UE in DC via an SCG, the SN deactivates, at block 1104B, the SCG (e.g., event 322A, 322B, 322C, 322D, 422A, 422B, 422C, 422D, 522A, 522B).

At block 1105B, the SN activates the SCG after deactivating the SCG (e.g., event 334A, 334B, 334D, 434A, 434B, 434D, 534A, 534B, 634, 734). At block 1107B, the SN retains operating information in at least one protocol layer for communication with the UE on (i.e., via) the SCG in response to activating the SCG. After activating the SCG, the SN communicates with the UE on the SCG using the at least one protocol layer with the retained operating information.

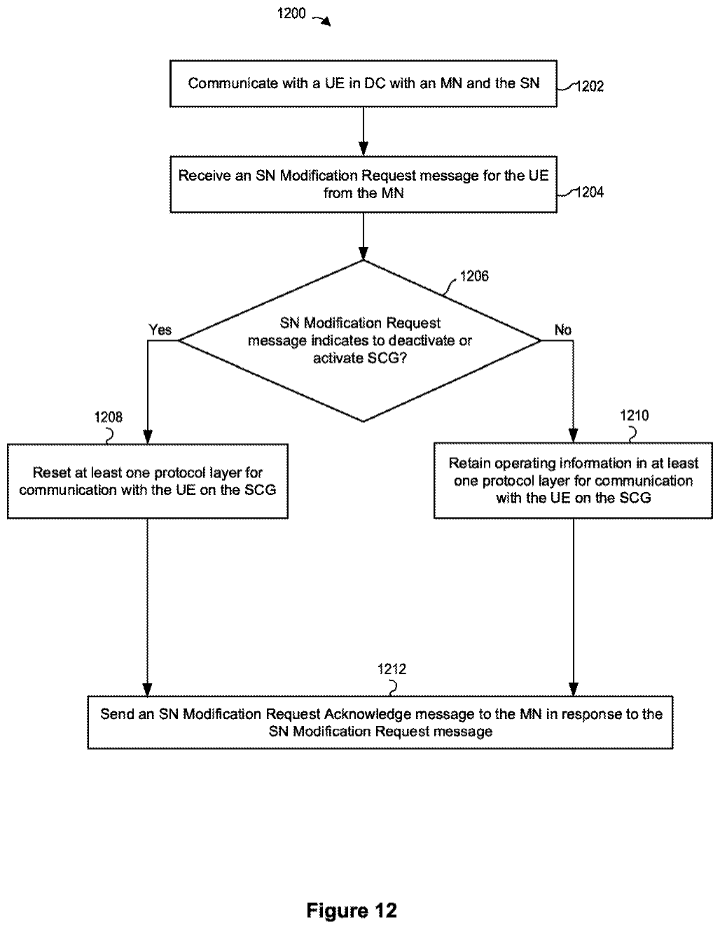

The at least one protocol layer in methods 1000A-B and 1100A-B can include PHY202A/202B, MAC 204A/204B, RLC 206A/206B, PDCP 208/210, and/or SDAP 212. In some implementations, the at least one protocol layer in methods 1000A-B and 1100A-B can be different, and therefore any of methods 1000A-B and 1100A-B can be combined. In other implementations, the at least one protocol layer in the methods 1600A-B and 1700A-B can be the same. In other implementations, the at least one protocol layer in methods 1000A-B and 1100A-B can be the same, and therefore any of methods 1000A-B and 1100A-B can be combined when different conditions are met as described in FIG. 12.

FIG. 12 is a flow diagram of a method 1200 for responding to an SN Modification Request message received from an MN for a UE, which can be implemented by an SN (e.g., the SN 106A or the CU 172 and the S-DU 174B of the base station 106A). Initially, at block 1202, the SN communicates with a UE (e.g., the UE 102) in DC with an MN (e.g., the MN 104A or the CU 172 and M-DU 174A of the base station 106A) and the SN (e.g., event 302A, 302B, 302C, 302D, 402A, 402B, 402C, 402D, 502A, 502B, 602, 702). While communicating with the UE in DC via an SCG, the SN deactivates, at block 1204, the SN receives an SN Modification Request message for the UE from an MN (e.g., event 310A, 410A).

At block 1206, the SN determines whether the SN Modification Request message indicates to deactivate or activate the SCG. If the SN Modification Request message indicates to deactivate or activate the SCG, the SN at block 1208 resets (or re-establish) at least one lower layer for communication with the UE on the SCG. If the SN Modification Request message indicates to neither deactivate nor activate the SCG, the SN at block 1210 retains operating information in at least one lower layer for communication with the UE on the SCG. Then the SN at block 1212 send an SN Modification Request Acknowledge message to the MN in response to the SN Modification Request message.

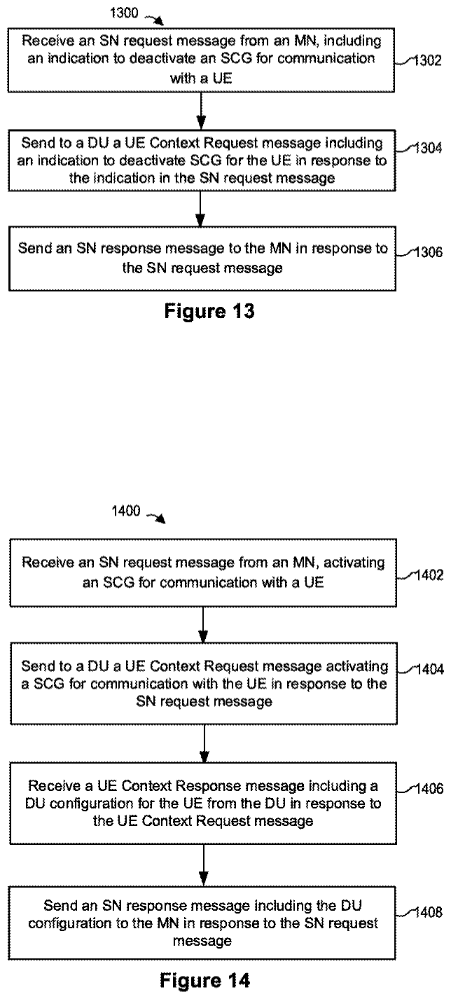

FIG. 13 is a flow diagram depicting a method 1300 for deactivating an SCG, which may be implemented by a CU of an SN (e.g., the CU 172 of the SN 106A) of this disclosure. Initially, at block 1302, the CU receives an SN request message from an MN (e.g., the MN 104A), including an indication to deactivate an SCG for communication with the UE (e.g., event 310A, 410A). At block 1304, the CU sends to a DU (e.g., the DU 174 of the SN 106A) a UE Context Request message including an indication to deactivate SCG for communication with the UE in response to the indication in the SN request message (e.g., event 472A). At block 1306, the CU sends an SN response message to the MN in response to the SN request message (e.g., event 412A).

FIG. 14 is a flow diagram depicting a method 1400 for activating an SCG, which may be implemented by a CU of an SN (e.g., the CU 172 of the SN 106A) of this disclosure. Initially, at block 1402, the CU receives an SN request message from an MN (e.g., the MN 104A), activating an SCG for communication with the UE (e.g., event 330A, 430A). At block 1404, the CU sends to a DU (e.g., the DU 174 of the SN 106A) a UE Context Request message activating SCG for communication with the UE in response to the SN request message (e.g., event 476A). At block 1406, the CU receives a UE Context Response message including a DU configuration for the UE from the DU in response to the UE Context Request message (e.g., event 478A). At block 1408, the CU sends an SN response message including the DU configuration to the MN in response to the SN request message (e.g., event 432A).

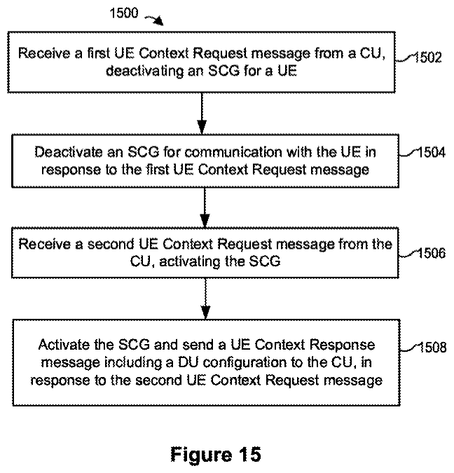

FIG. 15 is a flow diagram depicting a method 1500 for activating an SCG, which may be implemented by a DU of an SN (e.g., the DU 174 of the SN 106A, the S-DU 174B of the base station 106A) of this disclosure. Initially, at block 1502, the DU receives a first UE Context Request message from a CU (e.g., the CU 172 of the SN 106A, the CU 172 of the base station 106A), deactivating an SCG for communication with the UE (e.g., event 472A). The DU at block 1504 deactivates an SCG for communication with the UE in response to the first UE Context Request message (e.g., event 422A). At block 1506, the DU receives from the CU a second UE Context Request message activating the SCG (e.g., event 476A). In response to the second UE Context Request message, the DU at block 1508 activates the SCG and send a UE Context Response message including a DU configuration to the CU (e.g., event 434A, 478A).

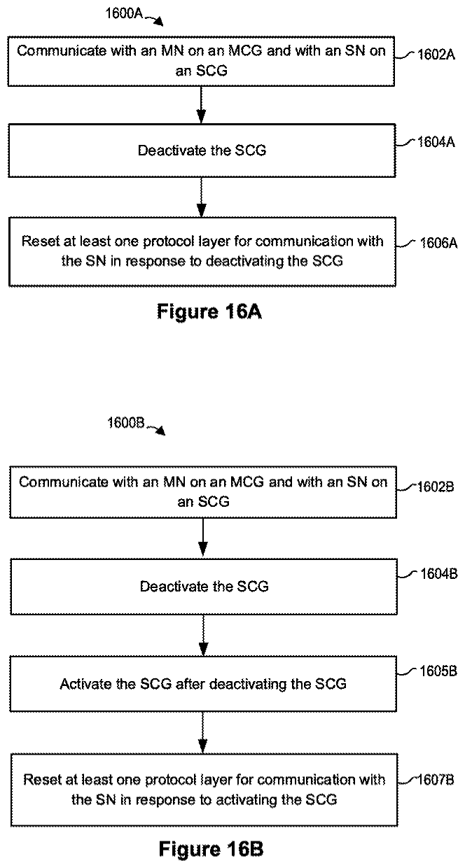

FIG. 16A is a flow diagram depicting a method 1600A for deactivating an SCG, which may be implemented by a UE (e.g., the UE 102) of this disclosure. Initially, at block 1602A, the UE communicates in DC with an MN (e.g., the MN 104A or the CU 172 and M-DU 174A of the base station 106A) and an SN (e.g., the SN 106A or the CU 172 and the S-DU 174B of the base station 106A) in accordance with an MN configuration and an SN configuration, respectively (e.g., event 302A, 302B, 302C, 302D, 402A, 402B, 402C, 402D, 502A, 502B, 602, 702). While communicating in DC with the MN (e.g., the MN 104A) and the SN through an MCG and an SCG respectively, the UE deactivates, at block 1604A, the SCG (e.g., event 316A, 316B, 316C, 316D, 416A, 416B, 416C, 416D, 516A, 516B). At block 1606A, the UE resets at least one protocol layer for communication with the SN on (i.e., via) the SCG in response to deactivating the SCG. After activating the SCG, the UE communicates with the SN on the SCG using the reset at least one protocol layer.

FIG. 16B is a flow diagram depicting a method 1600B for activating an SCG, which may be implemented by a UE (e.g., the UE 102) of this disclosure. Initially, at block 1602B, the UE communicates in DC with an MN (e.g., the MN 104A or the CU 172 and M-DU 174A of the base station 106A) and an SN (e.g., the SN 106A or the CU 172 and the S-DU 174B of the base station 106A) in accordance with an MN configuration and an SN configuration, respectively (e.g., event 302A, 302B, 302C, 302D, 402A, 402B, 402C, 402D, 502A, 502B, 602, 702). While communicating in DC with the MN (e.g., the MN 104A) and the SN through an MCG and an SCG respectively, the UE deactivates, at block 1604B, the SCG (e.g., event 316A, 316B, 316C, 316D, 416A, 416B, 416C, 416D, 516A, 516B).

At block 1605B, the UE activates the SCG after deactivating the SCG (e.g., event 338A, 338B, 338D, 438A, 438B, 438D, 538A, 538B, 638, 738). At block 1607B, the UE resets (or re-establishes) at least one protocol layer for communication with the SN on (i.e., via) the SCG in response to activating the SCG. After resetting the at least one protocol layer, the UE communicates with the SN on the SCG using the at least one protocol layer.

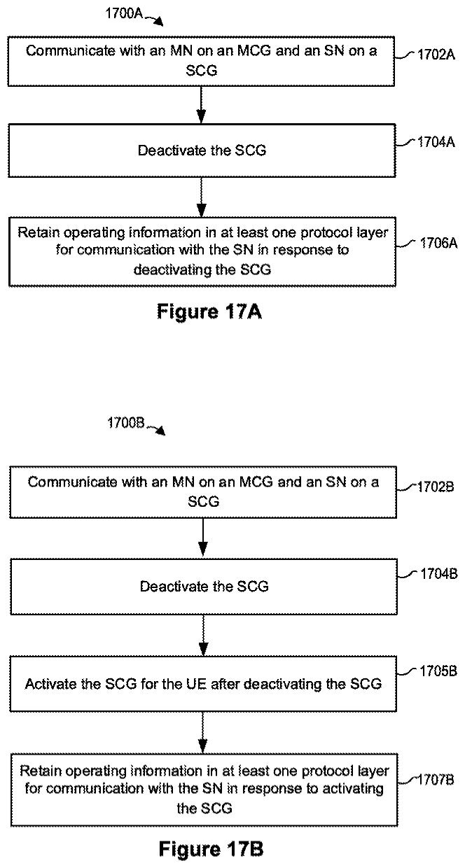

FIG. 17A is a flow diagram depicting a method 1700A for deactivating an SCG, which may be implemented by a UE (e.g., the UE 102) of this disclosure. Initially, at block 1702A, the UE communicates in DC with an MN (e.g., the MN 104A or the CU 172 and M-DU 174A of the base station 106A) and an SN (e.g., the SN 106A or the CU 172 and the S-DU 174B of the base station 106A) in accordance with an MN configuration and an SN configuration, respectively (e.g., event 302A, 302B, 302C, 302D, 402A, 402B, 402C, 402D, 502A, 502B, 602, 702). While communicating in DC with the MN (e.g., the MN 104A) and the SN through an MCG and an SCG respectively, the UE deactivates, at block 1704A, the SCG (e.g., event 316A, 316B, 316C, 316D, 416A, 416B, 416C, 416D, 516A, 516B). At block 1706A, the UE retains operating information in at least one protocol layer for communication with the SN on (i.e., via) the SCG in response to deactivating the SCG. After activating the SCG, the UE communicates with the SN on the SCG using the at least one protocol layer with the retained operating information.

FIG. 17B is a flow diagram depicting a method 1700B for activating an SCG, which may be implemented by a UE (e.g., the UE 102) of this disclosure. Initially, at block 1702B, the UE communicates in DC with an MN (e.g., the MN 104A or the CU 172 and M-DU 174A of the base station 106A) and an SN (e.g., the SN 106A or the CU 172 and the S-DU 174B of the base station 106A) in accordance with an MN configuration and an SN configuration, respectively (e.g., event 302A, 302B, 302C, 302D, 402A, 402B, 402C, 402D, 502A, 502B, 602, 702). While communicating in DC with the MN (e.g., the MN 104A) and the SN through an MCG and an SCG respectively, the UE deactivates, at block 1704B, the SCG (e.g., event 316A, 316B, 316C, 316D, 416A, 416B, 416C, 416D, 516A, 516B).

At block 1705B, the UE activates the SCG after deactivating the SCG (e.g., event 338A, 338B, 338D, 438A, 438B, 438D, 538A, 538B, 638, 738). At block 1707B, the UE retains operating information in at least one protocol layer for communication with the SCG on (i.e., via) the SCG in response to activating the SCG. After resetting the at least one protocol layer, the UE communicates with the SN on the SCG. After activating the SCG, the UE communicates with the SN on the SCG using the at least one protocol layer with the retained operating information.

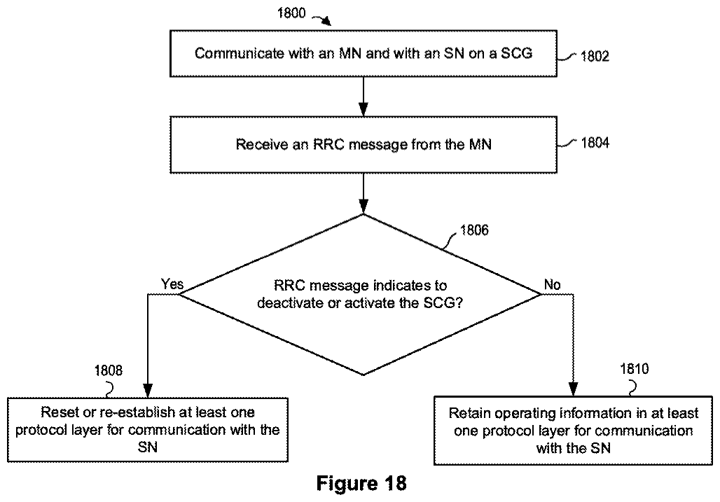

The at least one protocol layer in methods 1600A-B and 1170A-B can include PHY202A/202B, MAC 204A/204B, RLC 206A/206B, PDCP 208/210, and/or SDAP 212. In some implementations, the at least one protocol layer in the methods 1600A-B and 1700A-B can be different, and therefore any of the methods 1600A-B and 1700A-B can be combined. In other implementations, the at least one protocol layer in the methods 1600A-B and 1700A-B can be the same. In other implementations, the at least one protocol layer in methods 1600A-B and 1700A-B can be the same, and therefore any of methods 1600A-B and 1700A-B can be combined when different conditions are met as described in FIG. 18.

FIG. 18 is a flow diagram depicting a method 1800 for deactivating or activating an SCG, which may be implemented by a UE (e.g., the UE 102) of this disclosure. Initially, at block 1802, the UE communicates in DC with an MN (e.g., the MN 104A or the CU 172 and M-DU 174A of the base station 106A) and an SN (e.g., the SN 106A or the CU 172 and the S-DU 174B of the base station 106A) in accordance with an MN configuration and an SN configuration, respectively (e.g., event 302A, 302B, 302C, 302D, 402A, 402B, 402C, 402D, 502A, 502B, 602, 702). While communicating in DC with the MN (e.g., the MN 104A) and the SN through an MCG and an SCG respectively, the UE receives, at block 1804, an RRC message from the MN (e.g., event 314A, 314B, 314C, 314D, 414A, 414B, 414C, 414D, 514A, 514B, 336A, 336B, 336D, 436A, 436B, 436D, 536A, 536B, 636, 736).

At block 1806, the SN determines whether the RRC message indicates to deactivate or activate the SCG. If the RRC message indicates to deactivate or activate the SCG, the UE at block 1808 resets (or re-establish) at least one lower layer for communication with the SN on the SCG. If the RRC message indicates to neither deactivate nor activate the SCG, the UE at block 1810 retains operating information in at least one lower layer for communication with the SN on the SCG.

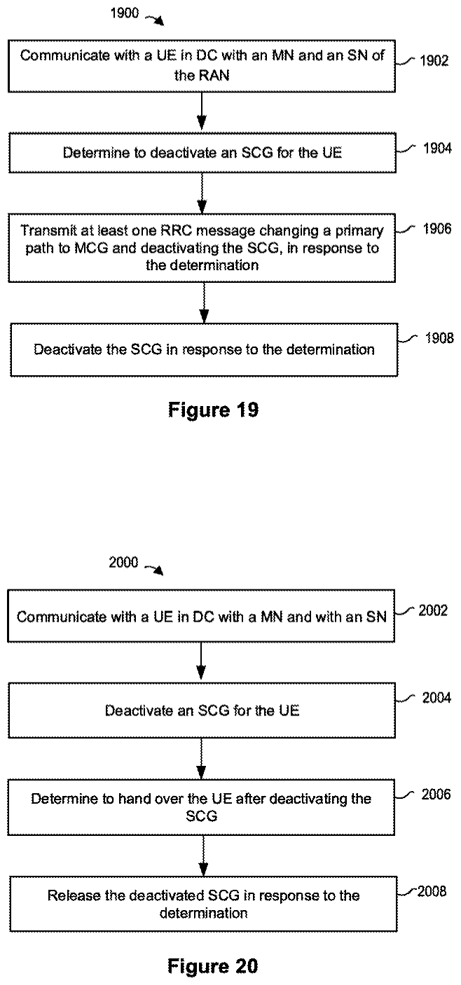

FIG. 19 is a flow diagram depicting a method 1900 for activating an SCG, which may be implemented by a RAN (e.g., RAN 105) of this disclosure. The RAN consists of an MN (e.g., the MN 104A or the CU 172 and M-DU 174A of the base station 106A) and an SN (e.g., the SN 106A or the CU 172 and the S-DU 174B of the base station 106A). Initially, at block 1902, the RAN communicates with a UE (e.g., the UE 102) in DC with an MN and the SN through an MCG and an SCG respectively (e.g., event 302A, 302B, 302C, 302D, 402A, 402B, 402C, 402D, 502A, 502B, 602, 702). While communicating with the UE in DC via the MCG and SCG, the RAN determines to deactivate, at block 1904, the SCG (e.g., event 308A, 307B, 307C, 408A, 407B, 407C, 508A).

At block 1906, the RAN transmits at least one RRC message changing a primary path to the MCG and deactivate the SCG in response to the determination (e.g., event 314A, 314B, 314C, 314D, 414A, 414B, 414C, 414D, 514A, 514B). At block 1908, the RAN deactivates the SCG in response to the determination (e.g., event 322A, 322B, 322C, 322D, 422A, 422B, 422C, 422D, 522A, 522B).

FIG. 20 is a flow diagram depicting a method 2000 for managing a deactivated SCG, which may be implemented by a RAN (e.g., RAN 105) of this disclosure. The RAN consists of an MN (e.g., the MN 104A or the CU 172 and M-DU 174A of the base station 106A) and an SN (e.g., the SN 106A or the CU 172 and the S-DU 174B of the base station 106A). Initially, at block 2002, the RAN communicates with a UE (e.g., the UE 102) in DC with the MN and the SN through an MCG and an SCG respectively (e.g., event 302A, 302B, 302C, 302D, 402A, 402B, 402C, 402D, 502A, 502B, 602, 702). While communicating with the UE in DC via the MCG and SCG, the RAN deactivates, at block 2004, the SCG (e.g., event 322A, 322B, 322C, 322D, 422A, 422B, 422C, 422D, 522A, 522B). At block 2006, the RAN (e.g., the MN) determines to hand over the UE after deactivating the SCG. At block 2008, the RAN releases the deactivated SCG in response to the determination. If the RAN does not release the deactivated SCG, the RAN in some implementations has to activate the SCG in the handover, causing the UE to activate the SCG.

In some implementations, the MN transmits to the UE a first RRC reconfiguration message releasing the deactivated SCG in response to the determination at event 2006. The MN can generate a release indicator to indicate releasing the deactivated SCG and include the release indicator in the first RRC reconfiguration message. In response, the UE releases the deactivated SCG and can transmit a first RRC reconfiguration complete message to the MN.

In some implementations, the MN transmits a handover command message to the UE to cause the UE to perform a handover, in response to the determination at event 2006. The UE performs a handover to a cell of the MN or another base station in accordance with the handover command message. The UE can perform a random access procedure on the cell as described above and transmit a handover complete message on the cell. The MN transmits the handover command message to the UE after transmitting the first RRC reconfiguration message or receiving the first RRC reconfiguration complete message.

In some implementations, the handover command message and the handover complete message can be a second RRC reconfiguration message and a second RRC reconfiguration complete message respectively. In other implementations, the MN can transmit to the UE a single RRC reconfiguration message releasing the deactivated SCG and commanding the handover. The UE transmits a single RRC reconfiguration complete message on the cell in response to the single RRC reconfiguration message.

Example implementations of the RRC reconfiguration message and RRC reconfiguration complete message are as described above.

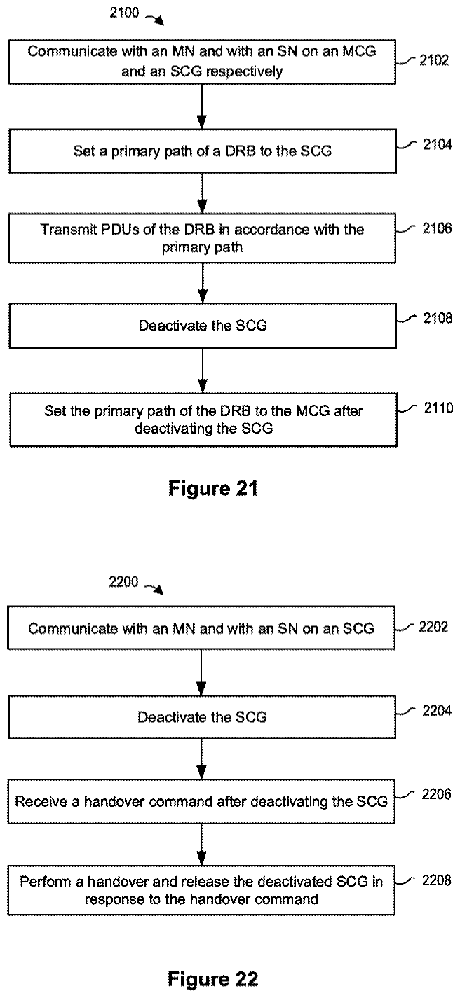

FIG. 21 is a flow diagram depicting a method 2100 for deactivating an SCG, which may be implemented by a UE (e.g., the UE 102) of this disclosure. Initially, at block 2100, the UE communicates in DC with an MN (e.g., the MN 104A or the CU 172 and M-DU 174A of the base station 106A) and an SN (e.g., the SN 106A or the CU 172 and the S-DU 174B of the base station 106A) in accordance with an MN configuration and an SN configuration, respectively (e.g., event 302A, 302B, 302C, 302D, 402A, 402B, 402C, 402D, 502A, 502B, 602, 702). At block 2104, the UE sets a primary path of a DRB to the SCG. Then the UE transmits, at block 2106, PDUs of the DRB in accordance with the primary path (i.e., the SCG). That is, the UE transmits PDUs on the DRB via the primary path.

While communicating in DC with the MN (e.g., the MN 104A) and the SN through an MCG and an SCG respectively, the UE deactivates, at block 2108, the SCG (e.g., event 316A, 316B, 316C, 316D, 416A, 416B, 416C, 416D, 516A, 516B). At block 2110, the UE sets the primary path of the DRB to the MCG after deactivating the SCG. If the UE has PDUs of the DRB to transmit after deactivating the SCG, the UE can transmit the PDUs of the DRB in accordance with the primary path (i.e., the MCG).

FIG. 22 is a flow diagram depicting a method 2200 for activating an SCG, which may be implemented by a UE (e.g., the UE 102) of this disclosure. Initially, at block 2202, the UE communicates in DC with an MN (e.g., the MN 104A or the CU 172 and M-DU 174A of the base station 106A) and an SN (e.g., the SN 106A or the CU 172 and the S-DU 174B of the base station 106A) in accordance with an MN configuration and an SN configuration, respectively (e.g., event 302A, 302B, 302C, 302D, 402A, 402B, 402C, 402D, 502A, 502B, 602, 702). While communicating in DC with the MN (e.g., the MN 104A) and the SN through an MCG and an SCG respectively, the UE deactivates, at block 2204, the SCG (e.g., event 316A, 316B, 316C, 316D, 416A, 416B, 416C, 416D, 516A, 516B). At block 2206, the UE receives a handover command message after deactivating the SCG. At block 2208, the UE performs a handover and release the deactivated SCG in response to the handover command.

Example implementations described for method 2000 can apply to method 2100. In some implementations, if the handover command does not include information (e.g., the release indicator) indicating to release the deactivated SCG, the UE autonomously releases the deactivated SCG in response to the handover command message. Thus, the UE can avoid the inefficiency that the RAN has to activate the deactivated SCG in handover even though there is no data activity on the SCG.

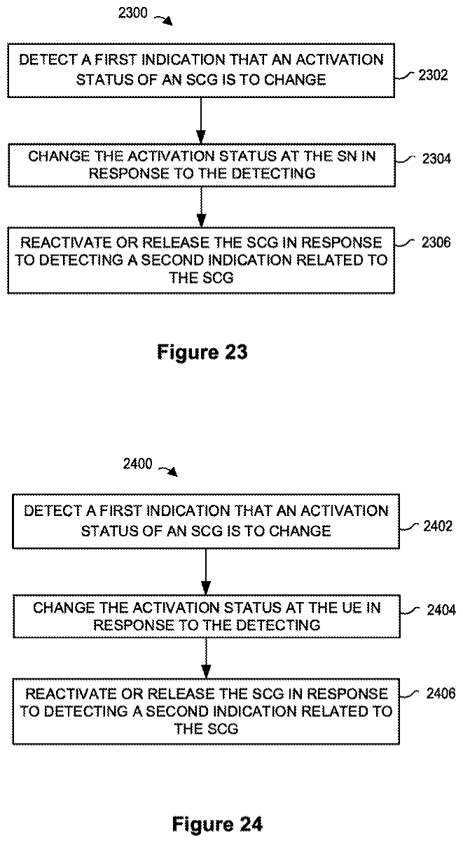

Referring to FIG. 23, an example method 2300 can be implemented in a network node network node, operating as an SN (e.g., the SN 106A) for a UE communicating in DC with an MN (e.g., the MN 104A) and the SN, for managing deactivation and activation of a secondary cell group (SCG). At block 2302, the network node detects a first indication that an activation status of the SCG is to change (e.g., event 310A, 305B-C, 307B-C, 384D, 410A, 472A-D, 405B-C, 407B-C, 484D, 562A, 508A, 572A, 585B. At block 2304, the network node changes the activation status at the SN in response to the detecting (e.g., event 322A-D, 422A-D, 522A-B. At block 2306, the network node reactivates or releases the SCG in response to detecting a second indication related to the SCG (e.g., event 334A-D, 434A-D, 545A-B, 692, 792). Reactivating the SCG, for example, can include applying a stored configuration that the SN used to communicate with the UE prior to changing the activation status. Alternatively, the SN may provide a new configuration to the UE that the UE is to use to communicate with the SN upon reactivating the SCG.

Referring to FIG. 24, an example method 2400 can be implemented in UE (e.g., the UE 102), communicating in DC with a RAN (e.g., the RAN 105) via an MN (e.g., the MN 104A) and an SN (e.g., the SN 106A), for managing deactivation and activation of an SCG. At block 2402, the UE detects a first indication that an activation status of the SCG is to change (e.g., event 314A-B, 315C, 382D, 414A-B, 415C, 482D, 514A, 582B). At block 2404, the UE changes the activation status at the UE in response to the detecting (e.g., event 316-D, 416A-D, 516A-B. At block 2406, the UE reactivates or releases the SCG in response to detecting a second indication related to the SCG (e.g., event 338A-D, 438A-D, 538A-B, 636, 736). Reactivating the SCG, for example, can include using a stored configuration that the UE used to communicate with the SN prior to changing the activation status. Alternatively, the UE may receive a new configuration from the RAN that the UE is to use to communicate with the SN upon reactivating the SCG.

The following list of examples reflects a variety of the embodiments explicitly contemplated by the present disclosure:
Example 1. A method in a network node, operating as a secondary node (SN) for a user equipment (UE) communicating in dual connectivity (DC) with a master node (MN) and the SN, for managing deactivation and activation of a secondary cell group (SCG), the method comprising: detecting, by a processing hardware of the network node, a first indication that an activation status of the SCG is to change; changing, by the processing hardware, the activation status at the SN in response to the detecting; and reactivating or releasing, by the processing hardware, the SCG in response to detecting a second indication related to the SCG.
Example 2. The method of example 1, wherein detecting the first indication includes: receiving, by the processing hardware, a request from the MN to deactivate the SCG.
Example 3. The method of example 2, wherein request is an SN modification request.
Example 4. The method of example 1, wherein detecting the first indication includes determining that the SCG is inactive based on monitoring, at the SN, data activity on the SCG.
Example 5. The method of example 4, further comprising: in response to detecting the first indication, transmitting to the MN a message indicating that the SCG is inactive.
Example 6. The method of any one of example 4 or 5, further comprising: in response to detecting the first indication, transmitting to the UE a message to deactivate the SCG.
Example 7. The method of example 6, wherein the message conforms to a protocol for controlling radio resources.
Example 8. The method of example 1, wherein detecting the first indication includes: receiving, by the processing hardware from the UE, a command to deactivate the SCG.
Example 9. The method of example 1, wherein detecting the first indication includes: receiving, by the processing hardware from the UE, an indication that the UE prefers single connectivity (SC).
Example 10. The method of any one of the preceding examples, wherein changing the activation status includes: receiving, by the processing hardware, a message indicating that the UE has deactivated the SCG; and deactivating the SCG subsequently to receiving the message.
Example 11. The method of example any one of the preceding examples, wherein: detecting the second indication includes determining that the UE is to perform a handover; and reactivating or releasing the SCG includes releasing the SCG.
Example 12. The method of any one of examples 1-10, wherein reactivating or releasing the SCG includes reactivating the SCG.
Example 13. The method of example 12, wherein reactivating the SCG includes performing a random access procedure initiated by the UE.
Example 14. The method of example 13, wherein: the network node is a distributed unit (DU) of the SN; the method further comprising: transmitting, from the DU to the CU, a DU to CU message indicating that the DU has reactivated the SCG.
Example 15. The method of any one of examples 12-14, further comprising: transmitting, by the processing hardware to the UE, a new configuration that the UE is to use to communicate with the SN upon reactivating the SCG.
Example 16. The method of any one of the preceding examples, further comprising: resetting, by the processing hardware, at least one parameter of a protocol layer at or below a radio link control layer in response to changing the activation status or reactivating the SCG.
Example 17. The method of any one of the preceding examples, further comprising: retaining, by the processing hardware, at least one parameter of a protocol layer at or below a radio link control layer in response to changing the activation status or reactivating the SCG.
Example 18. The method of any one of examples 1-13 or 15-17, wherein: the network node is a central unit (CU) of the SN; and changing the activation status includes: transmitting, by the processing hardware to a distributed unit (DU), a UE context request message indicating a change in the activation status.
Example 19. The method of example 18, wherein: the DU is a first DU; the CU and the first DU collectively operate as the SN; and the CU and a second DU collectively operate as the MN.
Example 20. A network node of a radio access network (RAN) including processing hardware and configured to implement a method according to any one of the preceding examples.
Example 21. A method in a user equipment (UE), communicating in dual connectivity with a RAN via a master node (MN) and a secondary node (SN), for managing deactivation and activation of a secondary cell group (SCG), the method comprising: detecting, by a processing hardware of the UE, a first indication that an activation status of the SCG is to change; changing, by the processing hardware, the activation status at the UE in response to the detecting; and reactivating or releasing, by the processing hardware, the SCG in response to detecting a second indication related to the SCG.
Example 22. The method of example 21, wherein detecting the first indication includes: determining that the SCG is inactive based on monitoring, at the UE, data activity on the SCG.
Example 23. The method of example 21 or 22, wherein the detecting the first indication includes: detecting a battery level of the UE.
Example 24. The method of any one of examples 21-23, further comprising: transmitting, by the processing hardware to the RAN, a command to deactivate the SCG.
Example 25. The method of example 21, wherein detecting the first indication includes: receiving, by the processing hardware from the RAN, a request to deactivate the SCG.
Example 26. The method of example 25, wherein the request conforms to a protocol for controlling radio resources.
Example 27. The method of example 25 or 26, further comprising: transmitting, by the processing hardware to the RAN prior to detecting the first indication, an indication that the UE prefers single connectivity (SC).
Example 28. The method of any one of examples 21-27, wherein: detecting the second indication includes receiving a handover command from the RAN; and reactivating or releasing the SCG includes releasing the SCG.
Example 29. The method of any one of examples 21-28, wherein: communicating in DC includes transmitting packets over a DRB having a primary path to the SCG; and the method further comprises: changing, by the processing hardware, the primary path of the DRB to the MCG in response to changing the activation status.
Example 30. The method of example 29, wherein: changing the primary path is further in response to receiving, by the processing hardware, a message from the RAN indicating that the UE is to change the primary path of the DRB to the MCG.
Example 31. The method of any one of examples 21-27, wherein reactivating or releasing the SCG includes reactivating the SCG.
Example 32. The method of example 31, wherein reactivating the SCG includes: performing, by the processing hardware, a random access procedure to connect with the SN.
Example 33. The method of example 31 or 32, wherein detecting the second indication includes receiving from the RAN a new configuration that the UE is to use to communicate with the SN upon reactivating the SCG.
Example 34. The method of any one of examples 21-33, further comprising: resetting, by the processing hardware, at least one parameter of a protocol layer at or below a radio link control layer in response to changing the activation status or reactivating the SCG.
Example 35. The method of any one of examples 21-34, further comprising: retaining, by the processing hardware, at least one parameter of a protocol layer at or below a radio link control layer in response to changing the activation status or reactivating the SCG.
Example 36. A user equipment (UE) including processing hardware and configured to implement a method according to any one of examples 21-35.

### ADDITIONAL CONSIDERATIONS

The following additional considerations apply to the foregoing discussion.

In some implementations, “message” is used and can be replaced by “information element (IE)”. In some implementations, “IE” is used and can be replaced by “field”. In some implementations, “configuration” can be replaced by “configurations” or the configuration parameters included in the MN or SN configuration described above. For example, “SN configuration” can be replaced by “SN configurations”. The SN configuration can be replaced by a cell group configuration and/or radio bearer configuration. In some implementations, “deactivating an SCG” can be replaced by “suspending an SCG” and “activating an SCG” can be replaced by “resuming an SCG” or “reactivating an SCG”. In some implementations, “lower layer” can be replaced by “protocol layer”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can include dedicated circuitry or logic that is permanently configured (e.g., as a special-purpose processor, such as a field programmable gate array (FPGA) or an application-specific integrated circuit (ASIC), a digital signal processor (DSP)) to perform certain operations. A hardware module may also include programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional and alternative structural and functional designs for deactivating and activating an SCG through the principles disclosed herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A method implemented in a network node, operating as a secondary node (SN) for a user equipment (UE) communicating in dual connectivity (DC) with a master node (MN) and the SN, for managing deactivation and activation of a secondary cell group (SCG), the method comprising:
detecting a first indication that an activation status of the SCG is to change;
changing the activation status at the SN in response to the detecting;
reactivating or releasing the SCG in response to detecting a second indication related to the SCG; and
resetting or retaining at least one parameter of a protocol layer at or below a radio link control layer in response to changing the activation status or reactivating the SCG.

2. The method of claim 1, wherein detecting the first indication includes:
receiving, from the UE, an indication that the UE prefers single connectivity (SC).

3. The method of claim 1, wherein changing the activation status includes:
receiving a message indicating that the UE has deactivated the SCG; and
deactivating the SCG subsequently to receiving the message.

4. The method of claim 1, wherein:
detecting the second indication includes determining that the UE is to perform a handover; and
reactivating or releasing the SCG includes releasing the SCG.

5. The method of claim 1, wherein receiving the second indication includes receiving the second indication from the MN.

6. The method of claim 1, wherein:
the network node is a distributed unit (DU) of the SN;
the method further comprising:
transmitting, from the DU to the CU, a DU to CU message indicating that the DU has reactivated the SCG.

7. The method of claim 1, wherein:
the network node is a central unit (CU) of the SN; and
changing the activation status includes:
transmitting, to a distributed unit (DU), a UE context request message indicating a change in the activation status.

8. The method of claim 7, wherein:
the DU is a first DU;
the CU and the first DU collectively operate as the SN; and
the CU and a second DU collectively operate as the MN.

9. A network node of a radio access network (RAN) including processing hardware and configured to operate as a secondary node (SN) for a user equipment (UE) communicating in dual connectivity (DC) with a master node (MN) and the SN, the network node configured to:
detect a first indication that an activation status of a secondary cell group (SCG) is to change,
change the activation status at the SN in response to the detecting,
reactivate or release SCG in response to detecting a second indication related to the SCG, and
reset or retain at least one parameter of a protocol layer at or below a radio link control layer in response to changing the activation status or reactivating the SCG.

10. A method implemented in a user equipment (UE), communicating in dual connectivity with a RAN via a master node (MN) and a secondary node (SN), for managing deactivation and activation of a secondary cell group (SCG), the method comprising:
detecting a first indication that an activation status of the SCG is to change;
changing the activation status at the UE in response to the detecting;
reactivating the SCG in response to detecting a second indication related to the SCG; and
resetting at least one parameter of a protocol layer at or below a radio link control layer in response to reactivating the SCG.

11. The method of claim 10, further comprising:
transmitting, to the RAN prior to detecting the first indication, an indication that the UE prefers single connectivity (SC).

12. The method of claim 10, wherein:
communicating in DC includes transmitting packets over a DRB having a primary path to the SCG; and
the method further comprises:
receiving a message from the RAN indicating that the UE is to change the primary path of the DRB to the MCG; and changing, by the processing hardware, the primary path of the DRB to the MCG in response to receiving the message.

13. The method of claim 10, wherein detecting the second indication includes receiving from the RAN a new configuration that the UE is to use to communicate with the SN upon reactivating the SCG.

14. The method of claim 10, further comprising:
retaining at least one parameter of a protocol layer at or below a radio link control layer in response to reactivating the SCG.

15. (canceled)

16. The network node of claim 9, further configured to, in order to change the activation status:
receive a message indicating that the UE has deactivated the SCG; and
deactivate the SCG subsequently to receiving the message.

17. The network node of claim 9, further configured to:
to detect the second indication, determine that the UE is to perform a handover; and
to reactivate or release the SCG, release the SCG.

18. The network node of claim 9, further configured to receive second indication from the MN.

19. The network node of claim 9, wherein:
the network node is a distributed unit (DU) of the SN;
the DU is further configured to:
transmit, to the CU, a DU to CU message indicating that the DU has reactivated the SCG.

20. The network node of claim 9, wherein:
the network node is a central unit (CU) of the SN; and
to changing the activation status, the CU is configured to transmit, to a distributed unit (DU), a UE context request message indicating a change in the activation status.

21. The network node of claim 20, wherein:
the DU is a first DU;
the CU and the first DU collectively operate as the SN; and
the CU and a second DU collectively operate as the MN.
